(19) United States
(12) Patent Application Publication
(10) Pub. No.: US 2021/0289264 A1
(43) Pub. Date: Sep. 16, 2021

(54) APPEARANCE SEARCH USING A MAP

(71) Applicant: MOTOROLA SOLUTIONS, INC., Chicago, IL (US)

(72) Inventors: DANIEL BOOTH, VANCOUVER (CA); ERIC SJUE, VANCOUVER (CA); BRENNA RANDLETT, VANCOUVER (CA); GREG CONN, VANCOUVER (CA); CODY YARBROUGH, VANCOUVER (CA); KEN JESSEN, NEW WESTMINISTER (CA); RICK MORLANG, NORTH VANCOUVER (CA)

(21) Appl. No.: 16/816,565

(22) Filed: Mar. 12, 2020

(51) Int. Cl. H04N 21/472; H04N 21/4728; G06F 16/735; G06F 16/738; G06F 16/787; G06F 16/2457

(52) U.S. Cl. CPC H04N 21/47217; H04N 21/4728; G06F 16/24578; G06F 16/738; G06F 16/787; G06F 16/735

(57) ABSTRACT

A method for performing an appearance search using a map involves receiving search commencement input requesting that an appearance search for one or more objects-of-interest commence be performed. In response to the search commencement input, one or more video recordings for the one or more objects-of-interest are searched. In conjunction with a map on a display, one or more appearance search results depicting the one or more objects-of-interest are then displayed. Each of the appearance search results depicts the one or more objects-of-interest as captured by a camera at a time during the one or more video recordings, and is depicted in conjunction with the map at a location indicative of a geographical location of the camera. The method may be performed using a video surveillance system and stored on one or more computer-readable media for execution using that system.

### BACKGROUND

In certain contexts, intelligent processing and playback of recorded video is an important function to have in a video surveillance system. For example, a video surveillance system may include many cameras, each of which records video. The total amount of video recorded by those cameras, much of which is typically recorded concurrently, makes relying upon manual location and tracking of an object-of-interest that appears in the recorded video inefficient. Intelligent processing and playback of video, and in particular automated search functionality, may accordingly be used to increase the efficiency with which an object-of-interest can be identified using a video surveillance system.

### BRIEF DESCRIPTION OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 shows a block diagram of an example video surveillance system within which methods in accordance with example embodiments can be carried out.

FIG. 2 shows a block diagram of a client-side video review application, in accordance with certain example embodiments, that can be provided within the example surveillance system of FIG. 1.

FIG. 3 shows a user interface page including an image frame of a video recording that permits a user to commence a search for a person-of-interest, according to an example embodiment implemented using the client-side video review application of FIG. 2.

FIG. 4 shows a user interface page including image search results, a face thumbnail, and a body thumbnail of the person-of-interest, generated after a search for the person-of-interest has commenced and before a user has provided match confirmation user input, according to an example embodiment implemented using the client-side video review application of FIG. 2.

FIG. 5 shows a user interface page including image search results, a face thumbnail, and a body thumbnail of the person-of-interest, generated after a user has provided match confirmation user input, according to an example embodiment implemented using the client-side video review application of FIG. 2.

FIG. 6 shows a user interface page including image search results, a face thumbnail, and a body thumbnail of the person-of-interest, with the image search results limited to those a user has indicated show the person-of-interest, according to an example embodiment implemented using the client-side video review application of FIG. 2.

FIG. 7 shows a user interface page including image search results, a face thumbnail, and a body thumbnail of the person-of-interest, with the image search results showing the person-of-interest wearing different clothes than in FIGS. 3-6, according to an example embodiment implemented using the client-side video review application of FIG. 2.

FIGS. 8A and 8B show a user interface page including image search results, a face thumbnail, and a body thumbnail of the person-of-interest in which a resizable window placed over a bar graph representing appearance likelihood is used to select image search results over a first duration (FIG. 8A) and a second, longer duration (FIG. 8B), according to an example embodiment implemented using the client-side video review application of FIG. 2.

FIG. 9 shows a method for interfacing with a user to facilitate an image search for a person-of-interest, according to another example embodiment.

FIGS. 10A-10E depict a user interface page or portions thereof in various states while a facet search is being performed, according to another example embodiment.

FIGS. 11A-11E depict a user interface page or portions thereof in various states when a natural language facet search is being performed, according to another example embodiment.

FIGS. 12A, 12B, 13A, and 13B depict menus allowing a user to select various facets, according to additional example embodiments.

FIG. 14 depicts a user interface page depicting various image search results on a map, according to another example embodiment.

FIG. 15A depicts the user interface page of FIG. 14, in which a context menu is present that allows a user to commence a search for a person-of-interest shown in one of the image search results, according to another example embodiment.

FIGS. 15B and 15C depict the user interface page of FIG. 14 with the results of the search for the person-of-interest overlaid on the map, according to another example embodiment.

FIGS. 16A-16F depict the user interface page of FIG. 14 with search results appearing sequentially over time, according to another example embodiment.

FIG. 17A depicts the user interface page of FIG. 14, in which a context menu is present that allows a user to commence an image search for persons having facets depicted in one of the image search results overlaid on the map, according to another example embodiment.

FIG. 17B depicts the user interface page of FIG. 14 with the results of the facet search commenced using the context menu of FIG. 17A overlaid on the map, according to another example embodiment.

FIGS. 18A and 18B depict additional example embodiments of the user interface page.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF EXAMPLE EMBODIMENTS

According to a first aspect, there is provided a method comprising: receiving search commencement input requesting that an appearance search for one or more objects-of-interest commence; in response to the search commencement input, searching one or more video recordings for the one or more objects-of-interest; and displaying, in conjunction with a map on a display, one or more appearance search results depicting the one or more objects-of-interest, wherein each of the appearance search results depicts the one or more objects-of-interest as captured by a camera at a time during the one or more video recordings, and is depicted in conjunction with the map at a location indicative of a geographical location of the camera.

At least one of the appearance search results may be a still image of one of the one or more objects-of-interest.

At least one of the appearance search results may be a video recording of one of the one or more objects-of-interest.

The appearance search results may appear in an order corresponding to a sequence in which the appearance search results appear in the one or more video recordings.

The appearance search results may appear proportional to when the appearance search results appear in the one or more video recordings.

The method may further comprise: receiving playback input indicating that the appearance search results are to appear, wherein the playback input comprises a playback speed at which the appearance search results are to appear; and only causing the appearance search results to appear once the playback input is received, wherein the times at which the appearance search results appear are adjusted in proportion to the playback speed.

A path connecting sequentially appearing ones of the appearance search results may be displayed.

The method may further comprise: determining whether at least one of the appearance search results is located within a building; and if the at least one of the appearance search results is located within the building, determining at least one of an entrance and exit of the building. The path may pass through the at least one of an entrance and exit.

Searching the one or more video recordings may comprise searching for a single object-of-interest regardless of facets of the single object-of-interest.

The appearance search results may comprise the single object-of-interest, and the method may further comprise: receiving additional search commencement input indicating that a search is to be done for one or more objects-of-interest that share one or more facets of the single object-of-interest; in response to the additional search commencement input, searching the one or more video recordings for the one or more objects-of-interest that share the one or more facets of the single object-of-interest; and updating, on the display, the one or more appearance search results to depict the one or more objects-of-interest that share the one or more facets of the single object-of-interest.

The additional search commencement input may specify which of the one or more facets of the single object-of-interest are to be searched.

Searching the one or more video recordings may comprise searching for objects-of-interest comprising one or more facets of identical type and value.

The search commencement input may specify a descriptor and a tag of the one or more facets to be searched.

The appearance search results may comprise multiple objects-of-interest sharing one or more facets of identical descriptor and tag, and the method may further comprise: receiving additional search commencement input indicating that a search is to be done for a single object-of-interest comprising part of the appearance search results; in response to the additional search commencement input, searching the one or more video recordings for the single object-of-interest comprising part of the appearance search results regardless of facets of the single object-of-interest; and updating, on the display, the one or more appearance search results to depict the single object-of-interest comprising part of the appearance search results.

Each of the one or more facets may comprise age, gender, a type of clothing, a color of clothing, a pattern displayed on clothing, a hair color, a footwear color, or a clothing accessory.

Each of the one or more appearance search results may be associated with a confidence level, and the method may further comprise: receiving confidence level input specifying a minimum confidence level; and in response to the confidence level input, updating, on the display, the one or more appearance search results to depict only the one or more search results having a confidence level at or above the minimum confidence level.

At least one of the appearance search results may be overlaid on the map.

According to an aspect, the one or more objects-of-interest may comprise a vehicle, and wherein searching the one or more video recordings for the one or more objects-of-interest comprises searching the one or more video recordings for a license plate of the vehicle.

According to another aspect, there is provided a system comprising: a display; an input device; a processor communicatively coupled to the display and the input device;

and a memory communicatively coupled to the processor and having stored thereon computer program code that is executable by the processor, wherein the computer program code, when executed by the processor, causes the processor to perform the method of any of the foregoing aspects or suitable combinations thereof.

According to another aspect, there is provided a non-transitory computer readable medium having stored thereon computer program code that is executable by a processor and that, when executed by the processor, causes the processor to perform the method of any of the foregoing aspects or suitable combinations thereof.

Each of the above-mentioned embodiments will be discussed in more detail below, starting with example system and device architectures of the system in which the embodiments may be practiced, followed by an illustration of processing blocks for achieving an improved technical method, device, and system for an appearance search using a map. Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

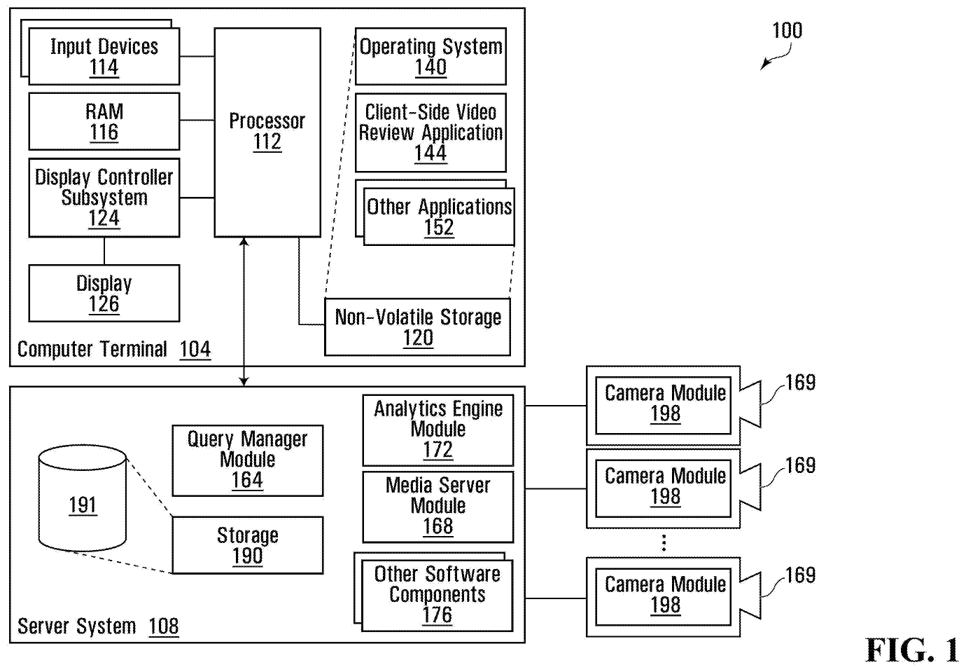

Reference is now made to FIG. 1 which shows a block diagram of an example surveillance system 100 within which methods in accordance with example embodiments can be carried out. Included within the illustrated surveillance system 100 are one or more computer terminals 104 and a server system 108. In some example embodiments, the computer terminal 104 is a personal computer system; however in other example embodiments the computer terminal 104 is a selected one or more of the following: a handheld device such as, for example, a tablet, a phablet, a smart phone or a personal digital assistant (PDA); a laptop computer; a smart television; and other suitable devices. With respect to the server system 108, this could comprise a single physical machine or multiple physical machines. It will be understood that the server system 108 need not be contained within a single chassis, nor necessarily will there be a single location for the server system 108. As will be appreciated by those skilled in the art, at least some of the functionality of the server system 108 can be implemented within the computer terminal 104 rather than within the server system 108.

The computer terminal 104 communicates with the server system 108 through one or more networks. These networks can include the Internet, or one or more other public/private networks coupled together by network switches or other communication elements. The network(s) could be of the form of, for example, client-server networks, peer-to-peer networks, etc. Data connections between the computer terminal 104 and the server system 108 can be any number of known arrangements for accessing a data communications network, such as, for example, dial-up Serial Line Interface Protocol/Point-to-Point Protocol (SLIP/PPP), Integrated Services Digital Network (ISDN), dedicated lease line service, broadband (e.g. cable) access, Digital Subscriber Line (DSL), Asynchronous Transfer Mode (ATM), Frame Relay, or other known access techniques (for example, radio frequency (RF) links). In at least one example embodiment, the computer terminal 104 and the server system 108 are within the same Local Area Network (LAN).

The computer terminal 104 includes at least one processor 112 that controls the overall operation of the computer terminal. The processor 112 interacts with various subsystems such as, for example, input devices 114 (such as a selected one or more of a keyboard, mouse, touch pad, roller ball and voice control means, for example), random access memory (RAM) 116, non-volatile storage 120, display controller subsystem 124 and other subsystems (not shown). The display controller subsystem 124 interacts with display 126 and it renders graphics and/or text upon the display 126.

Still with reference to the computer terminal 104 of the surveillance system 100, operating system 140 and various software applications used by the processor 112 are stored in the non-volatile storage 120. The non-volatile storage 120 is, for example, one or more hard disks, solid state drives, or some other suitable form of computer readable medium that retains recorded information after the computer terminal 104 is turned off.

Regarding the operating system 140, this includes software that manages computer hardware and software resources of the computer terminal 104 and provides common services for computer programs. Also, those skilled in the art will appreciate that the operating system 140, client-side video review application 144, and other applications 152, or parts thereof, may be temporarily loaded into a volatile store such as the RAM 116. The processor 112, in addition to its operating system functions, can enable execution of the various software applications on the computer terminal 104.

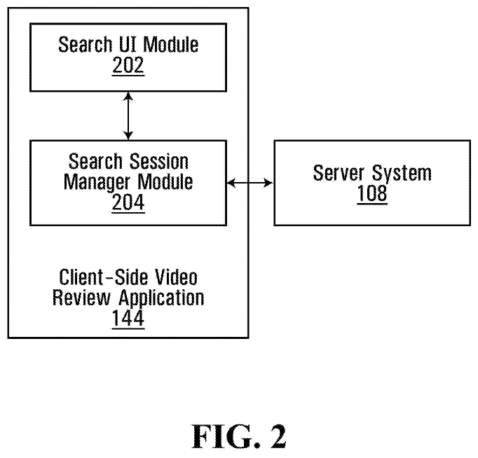

More details of the video review application 144 are shown in the block diagram of FIG. 2. The video review application 144 can be run on the computer terminal 104 and includes a search User Interface (UI) module 202 for cooperation with a search session manager module 204 in order to enable a computer terminal user to carry out actions related to providing input and, more specifically, input to facilitate identifying same individuals or objects appearing in a plurality of different video recordings. In such circumstances, the user of the computer terminal 104 is provided with a user interface generated on the display 126 through which the user inputs and receives information in relation the video recordings.

The video review application 144 also includes the search session manager module 204 mentioned above. The search session manager module 204 provides a communications interface between the search UI module 202 and a query manager module 164 (FIG. 1) of the server system 108. In at least some examples, the search session manager module 204 communicates with the query manager module 164 through the use of Remote Procedure Calls (RPCs).

Besides the query manager module 164, the server system 108 includes several software components for carrying out other functions of the server system 108. For example, the server system 108 includes a media server module 168. The media server module 168 handles client requests related to storage and retrieval of video taken by video cameras 169 in the surveillance system 100. The server system 108 also includes an analytics engine module 172. The analytics engine module 172 can, in some examples, be any suitable one of known commercially available software that carry out mathematical calculations (and other operations) to attempt computerized matching of same individuals or objects as between different portions of video recordings (or as between any reference image and video compared to the reference image). For example, the analytics engine module 172 can, in one specific example, be a software component of the Avigilon Control Center™ server software sold by Avigilon Corporation. In some examples the analytics engine module 172 can use the descriptive characteristics of the person's or object's appearance. Examples of these characteristics include the person's or object's shape, size, textures and color.

The server system 108 also includes a number of other software components 176. These other software components will vary depending on the requirements of the server system 108 within the overall system. As just one example, the other software components 176 might include special test and debugging software, or software to facilitate version updating of modules within the server system 108. The server system 108 also includes one or more data stores 190. In some examples, the data store 190 comprises one or more databases 191 which facilitate the organized storing of recorded video.

Regarding the video cameras 169, each of these includes a camera module 198.

In some examples, the camera module 198 includes one or more specialized integrated circuit chips to facilitate processing and encoding of video before it is even received by the server system 108. For instance, the specialized integrated circuit chip may be a System-on-Chip (SoC) solution including both an encoder and a Central Processing Unit (CPU) and/or Vision Processing Unit (VPU). These permit the camera module 198 to carry out the processing and encoding functions. Also, in some examples, part of the processing functions of the camera module 198 includes creating metadata for recorded video. For instance, metadata may be generated relating to one or more foreground areas that the camera module 198 has detected, and the metadata may define the location and reference coordinates of the foreground visual object within the image frame. For example, the location metadata may be further used to generate a bounding box, typically rectangular in shape, outlining the detected foreground visual object. The image within the bounding box may be extracted for inclusion in metadata. The extracted image may alternately be smaller then what was in the bounding box or may be larger then what was in the bounding box. The size of the image being extracted can also be close to, but outside of, the actual boundaries of a detected object.

In some examples, the camera module 198 includes a number of submodules for video analytics such as, for instance, an object detection submodule, an instantaneous object classification submodule, a temporal object classification submodule and an object tracking submodule. Regarding the object detection submodule, such a submodule can be provided for detecting objects appearing in the field of view of the camera 169. The object detection submodule may employ any of various object detection methods understood by those skilled in the art such as, for example, motion detection and/or blob detection.

Regarding the object tracking submodule that may form part of the camera module 198, this may be operatively coupled to both the object detection submodule and the temporal object classification submodule. The object tracking submodule may be included for the purpose of temporally associating instances of an object detected by the object detection submodule. The object tracking submodule may also generate metadata corresponding to visual objects it tracks.

Regarding the instantaneous object classification submodule that may form part of the camera module 198, this may be operatively coupled to the object detection submodule and employed to determine a visual objects type (such as, for example, human, vehicle or animal) based upon a single instance of the object. The input to the instantaneous object classification submodule may optionally be a sub-region of an image in which the visual object-of-interest is located rather than the entire image frame.

Regarding the temporal object classification submodule that may form part of the camera module 198, this may be operatively coupled to the instantaneous object classification submodule and employed to maintain class information of an object over a period of time. The temporal object classification submodule may average the instantaneous class information of an object provided by the instantaneous classification submodule over a period of time during the lifetime of the object. In other words, the temporal object classification submodule may determine a type of an object based on its appearance in multiple frames. For example, gait analysis of the way a person walks can be useful to classify a person, or analysis of the legs of a person can be useful to classify a cyclist. The temporal object classification submodule may combine information regarding the trajectory of an object (e.g. whether the trajectory is smooth or chaotic, whether the object is moving or motionless) and confidence of the classifications made by the instantaneous object classification submodule averaged over multiple frames. For example, determined classification confidence values may be adjusted based on the smoothness of trajectory of the object. The temporal object classification submodule may assign an object to an unknown class until the visual object is classified by the instantaneous object classification submodule subsequent to a sufficient number of times and a predetermined number of statistics having been gathered. In classifying an object, the temporal object classification submodule may also take into account how long the object has been in the field of view. The temporal object classification submodule may make a final determination about the class of an object based on the information described above. The temporal object classification submodule may also use a hysteresis approach for changing the class of an object. More specifically, a threshold may be set for transitioning the classification of an object from unknown to a definite class, and that threshold may be larger than a threshold for the opposite transition (for example, from a human to unknown). The temporal object classification submodule may aggregate the classifications made by the instantaneous object classification submodule.

In accordance with at least some examples, a feature vector is an n-dimensional vector of numerical features (numbers) that represent an image of an object processable by computers. By comparing the feature vector of a first image of one object with the feature vector of a second image, a computer implementable process may determine whether the first image and the second image are images of the same object.

Similarity calculation can be just an extension of the above. Specifically, by calculating the Euclidean distance between two feature vectors of two images captured by one or more of the cameras 169, a computer implementable process can determine a similarity score to indicate how similar the two images may be.

In some examples, the camera module 198 is able to detect humans and extract images of humans with respective bounding boxes outlining the human objects for inclusion in metadata which along with the associated video may be transmitted to the server system 108. At the server system 108, the media server module 168 can process extracted images and generate signatures (e.g. feature vectors) to represent objects. In this example implementation, the media server module 168 uses a learning machine to process the bounding boxes to generate the feature vectors or signatures of the images of the objects captured in the video. The learning machine is for example a neural network such as a convolutional neural network (CNN) running on a graphics processing unit (GPU). The CNN may be trained using training datasets containing millions of pairs of similar and dissimilar images. The CNN, for example, is a Siamese network architecture trained with a contrastive loss function to train the neural networks. An example of a Siamese network is described in Bromley, Jane, et al. “Signature verification using a “Siamese” time delay neural network.” International Journal of Pattern Recognition and Artificial Intelligence 7.04 (1993): 669-688, the contents of which is hereby incorporated by reference in its entirety.

The media server module 168 deploys a trained model in what is known as batch learning where all of the training is done before it is used in the appearance search system. The trained model, in this embodiment, is a CNN learning model with one possible set of parameters. There is, practically speaking, an infinite number of possible sets of parameters for a given learning model. Optimization methods (such as stochastic gradient descent), and numerical gradient computation methods (such as backpropagation) may be used to find the set of parameters that minimize the objective function (also known as a loss function). A contrastive loss function may be used as the objective function. A contrastive loss function is defined such that it takes high values when it the current trained model is less accurate (assigns high distance to similar pairs, or low distance to dissimilar pairs), and low values when the current trained model is more accurate (assigns low distance to similar pairs, and high distance to dissimilar pairs). The training process is thus reduced to a minimization problem. The process of finding the most accurate model is the training process, the resulting model with the set of parameters is the trained model, and the set of parameters is not changed once it is deployed onto the appearance search system.

In at least some alternative example embodiments, the media server module 168 may determine feature vectors by implementing a learning machine using what is known as online machine learning algorithms. The media server module 168 deploys the learning machine with an initial set of parameters; however, the appearance search system keeps updating the parameters of the model based on some source of truth (for example, user feedback in the selection of the images of the objects of interest). Such learning machines also include other types of neural networks as well as convolutional neural networks.

In accordance with at least some examples, storage of feature vectors within the surveillance system 100 is contemplated. For instance, feature vectors may are indexed and stored in the database 191 with respective video. The feature vectors may also be associated with reference coordinates to where extracted images of respective objects are located in respective video. Storing may include storing video with, for example, time stamps, camera identifications, metadata with the feature vectors and reference coordinates, etc.

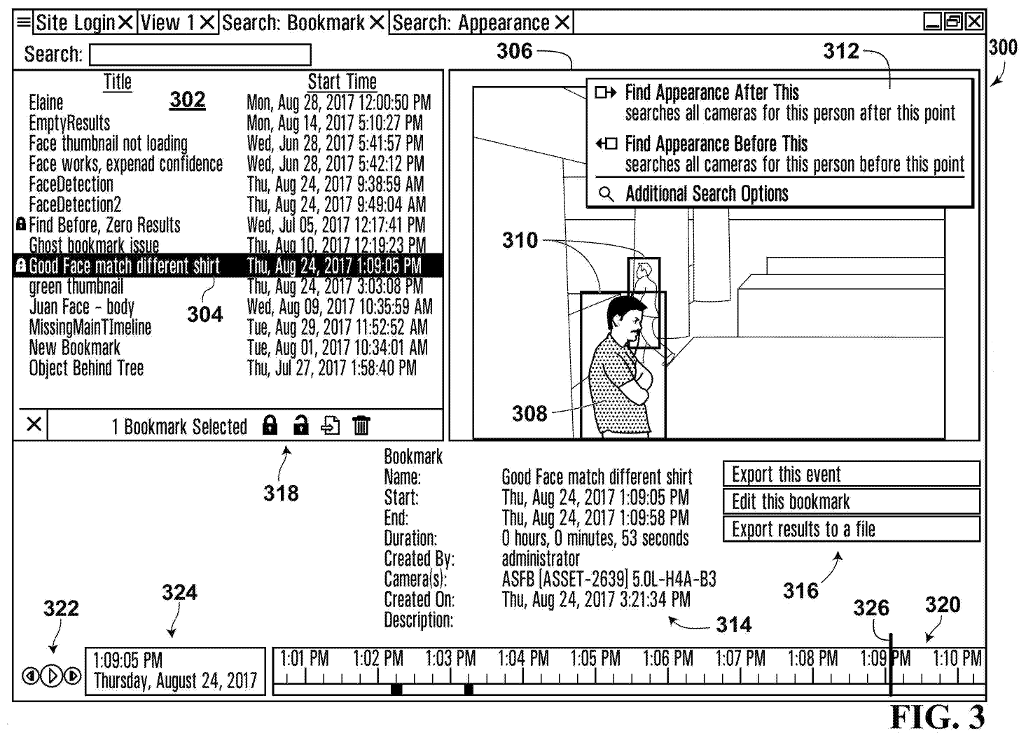

Referring now to FIGS. 3 to 8B, there are shown various user interface pages that the search UI module 202 displays to a user of the client-side video review application 144, according to one example embodiment. The embodiment depicted in FIGS. 2 to 8B permits the video review application's 144 user to commence a search for a person-of-interest and to have a face thumbnail and a body thumbnail of the person-of-interest displayed to assist the user in identifying the person-of-interest while reviewing image search results. As used herein, a “person-of-interest” is a person that the video review application's 144 user is attempting to locate using the surveillance system 100; a “body thumbnail” of a person displays at least a portion of a torso of that person; and a “face thumbnail” of a person displays at least a portion of a face of that person. In the depicted example embodiments, the body thumbnail of a person displays that person's head and torso, while the face thumbnail of that person shows, as a proportion of the total area of the thumbnail, more of that person's face than is shown in the body thumbnail. The server system 108 in the embodiment of FIGS. 2 to 8B is able to search any one or more of a collection of video recordings using any one or more of the cameras 169 based on one or both of the person-of-interest's body and face; the collection of video recordings may or may not be generated concurrently by the cameras 169. Permitting the body and face to be used during searching accordingly may help both the server system 108 and the user identify the person-of-interest, particularly when the person-of-interest's body changes appearance in different recordings or at different times (e.g., resulting from the person-of-interest changing clothes).

Referring now to FIG. 3 in particular, there is shown a user interface page 300 including an image frame 306 of a selected video recording that permits a user of the video review application 144 to commence a search for a person-of-interest 308. The selected video recording shown in FIG. 3 is one of the collection of video recordings obtained using different cameras 169 to which the user has access via the video review application 144. The video review application 144 displays the page 300 on the computer terminal's 104 display 126. The user provides input to the video review application 144 via the input device 114, which in the example embodiment of FIG. 3 comprises a mouse or touch pad. In FIG. 3, displaying the image frame 306 comprises the video review application 144 displaying the image frame 306 as a still image, although in different embodiments displaying the image frame 306 may comprise playing the selected video recording or playing the selected video recording.

The image frame 306 of the selected video recording occupies the entirety of the top-right quadrant of the page 300. The frame 306 depicts a scene in which multiple persons are present. The server system 108 automatically identifies persons appearing in the scene that may be the subject of a search, and thus who are potential persons-of-interest 308 to the user, and highlights each of those persons by enclosing all or part of each in a bounding box 310. In FIG. 3, the user identifies the person located in the lowest bounding box 310 as the person-of-interest 308, and selects the bounding box 310 around that person to evoke a context menu 312 that may be used to commence a search. The context menu 312 presents the user with one option to search the collection of video recordings at all times after the image frame 306 for the person-of-interest 308, and another option to search the collection of video recordings at all times before the image frame 306. The user may select either of those options to have the server system 108 commence searching for the person-of-interest 308. The input the user provides to the server system 108 via the video review application 144 to commence a search for the person-of-interest is the “search commencement user input”.

In FIG. 3, the user has bookmarked the image frame 306 according to which of the cameras 169 obtained it and its time index so as to permit the user to revisit that image frame 306 conveniently. Immediately below the image frame 306 is bookmark metadata 314 providing selected metadata for the selected video recording, such as its name and duration. To the right of the bookmark metadata 314 and below the image frame 306 are action buttons 316 that allow the user to perform certain actions on the selected video recording, such as to export the video recording.

Immediately to the left of the image frame 306 is a bookmark list 302 showing all of the user's bookmarks, with a selected bookmark 304 corresponding to the image frame 306. Immediately below the bookmark list 302 are bookmark options 318 permitting the user to perform actions such as to lock or unlock any one or more of the bookmarks to prevent them from being changed, to permit them to be changed, to export any one or more of the bookmarks, and to delete any one or more of the bookmarks.

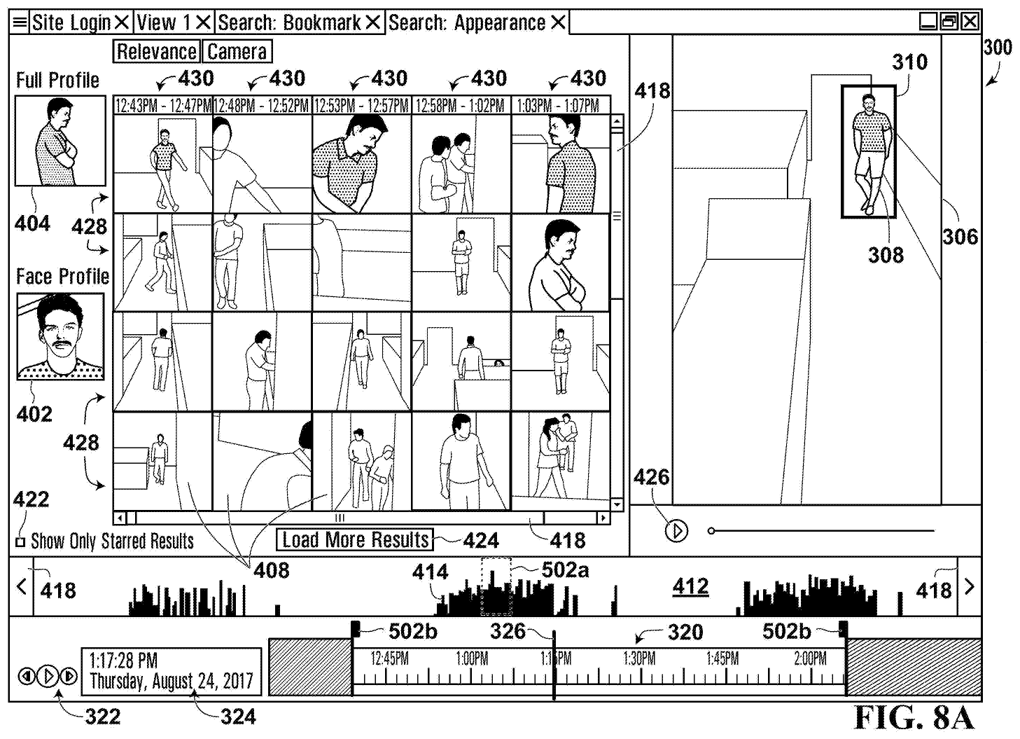

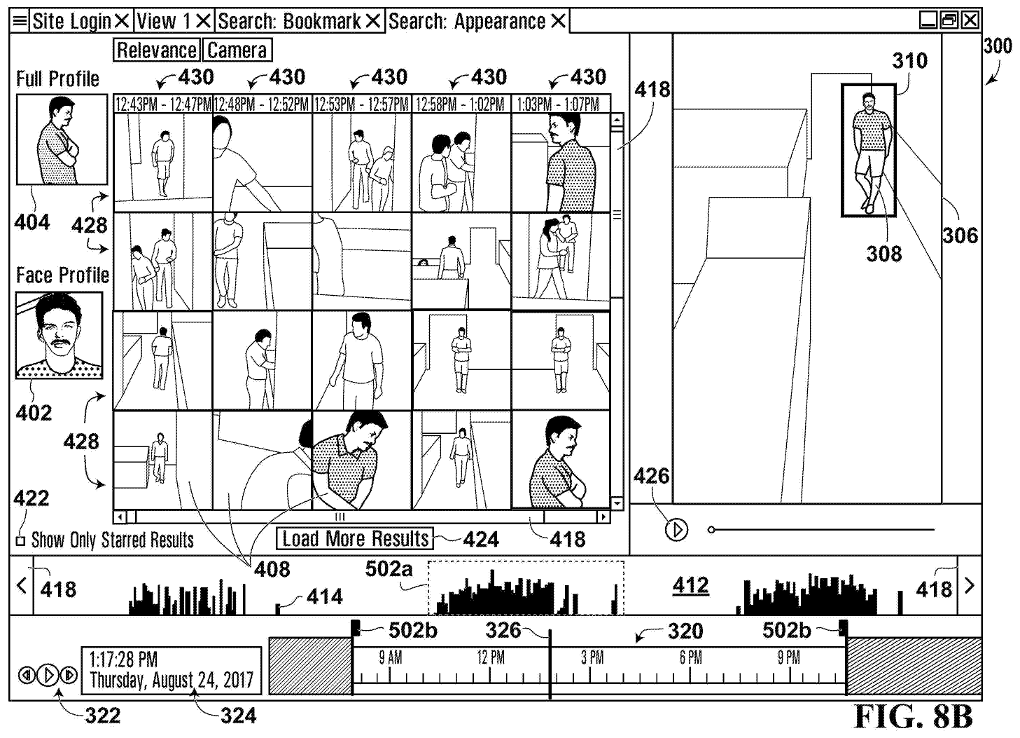

Immediately below the bookmark options 318 and bordering a bottom-left edge of the page 300 are video control buttons 322 permitting the user to play, pause, fast forward, and rewind the selected video recording. Immediately to the right of the video control buttons 322 is a video time indicator 324, displaying the date and time corresponding to the image frame 306. Extending along a majority of the bottom edge of the page 300 is a timeline 320 permitting the user to scroll through the selected video recording and through the video collectively represented by the collection of video recordings. The user may, for example, select a cursor 326 located along the timeline 320 and move the cursor 326 along the timeline to scroll to the time in the video corresponding to the cursor's 326 location. As discussed in further detail below in respect of FIGS. 8A and 8B, the timeline 320 is resizable in a manner that is coordinated with other features on the page 300 to facilitate searching.

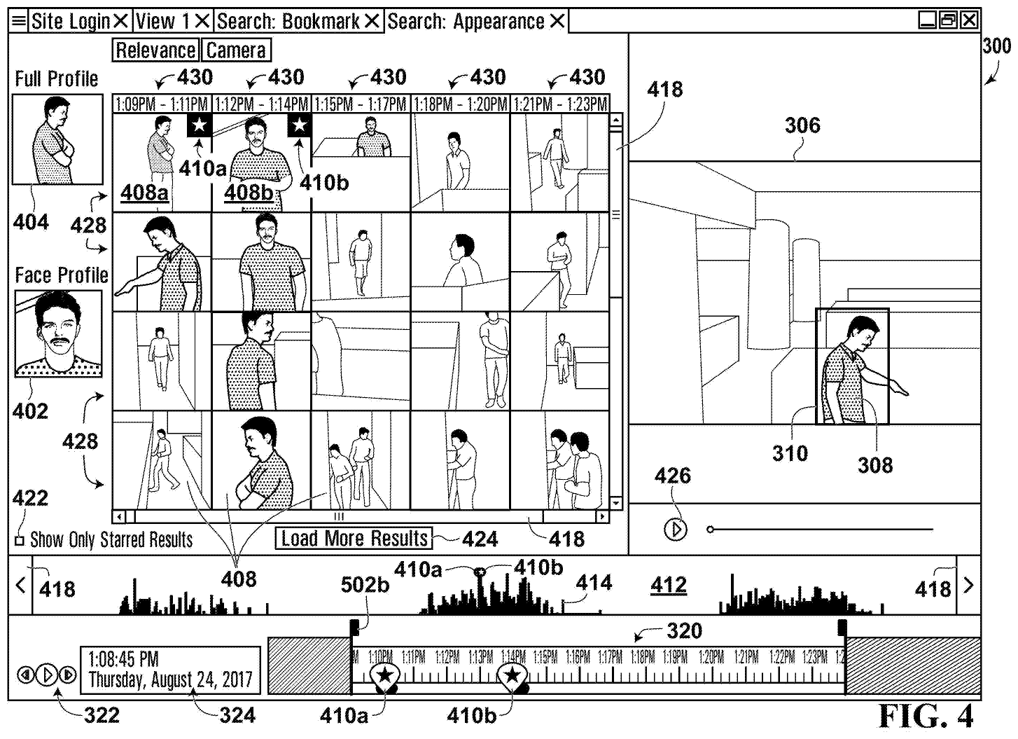

Referring now to FIG. 4, the user interface page 300 is shown after the server system 108 has completed a search for the person-of-interest 308. The page 300 concurrently displays the image frame 306 of the selected video recording the user used to commence the search bordering a right edge of the page 300; immediately to the left of the image frame 306, image search results 408 selected from the collection of video recordings by the server system 108 as potentially corresponding to the person-of-interest 308; and, immediately to the left of the image search results 408 and bordering a left edge of the page 300, a face thumbnail 402 and a body thumbnail 404 of the person-of-interest 308.

While video is being recorded, at least one of the cameras 169 and server system 108 in real-time identify when people, each of whom is a potential person-of-interest 308, are being recorded and, for those people, attempt to identify each of their faces. The server system 108 generates signatures based on the faces (when identified) and bodies of the people who are identified, as described above. The server system 108 stores information on whether faces were identified and the signatures as metadata together with the video recordings.

In response to the search commencement user input the user provides using the context menu 312 of FIG. 3, the server system 108 generates the image search results 408 by searching the collection of video recordings for the person-of-interest 308. The server system 108 performs a combined search including a body search and a face search on the collection of video recordings using the metadata recorded for the person-of-interest's 308 body and face, respectively. More specifically, the server system 108 compares the body and face signatures of the person-of-interest 308 the user indicates he or she wishes to perform a search on to the body and face signatures, respectively, for the other people the server system 108 has identified. The server system 108 returns the search results 408, which includes a combination of the results of the body and face searches, which the video review application 144 uses to generate the page 300. Any suitable method may be used to perform the body and face searches; for example, the server system 108 may use a convolutional neural network when performing the body search.

In one example embodiment, the face search is done by searching the collection of video recordings for faces. Once a face is identified, the coordinates of a bounding box that bounds the face (e.g., in terms of an (x,y) coordinate identifying one corner of the box and width and height of the box) and an estimation of the head pose (e.g., in terms of yaw, pitch, and roll) are generated. A feature vector may be generated that characterizes those faces using any one or more metrics, as discussed above.

In at least one example embodiment, the cameras 169 generate the metadata and associated feature vectors in or nearly in real-time, and the server system 108 subsequently assesses face similarity using those feature vectors. However, in at least one alternative example embodiment the functionality performed by the cameras 169 and server system 108 may be different. For example, functionality may be divided between the server system 108 and cameras 169 in a manner different than as described above. Alternatively, one of the server system 108 and the cameras 169 may generate the feature vectors and assess face similarity.

In FIG. 4, the video review application 144 uses as the body thumbnail 404 at least a portion of the image frame 306 that is contained within the bounding box 310 highlighting the person-of-interest. The video review application 144 uses as the face thumbnail 402 at least a portion of one of the face search results that satisfy a minimum likelihood that that result correspond to the person-of-interest's 308 face; in one example embodiment, the face thumbnail 402 is drawn from the result of the face search that is most likely to correspond to the person-of-interest's 308 face. Additionally or alternatively, the result used as the basis for the face thumbnail 402 is one of the body search results that satisfies a minimum likelihood that the result correspond to the person-of-interest's 308 body. In another example embodiment, the face thumbnail 402 may be selected as at least a portion of the image frame 306 that is contained within the bounding box 310 highlighting the person-of-interest 308 in FIG. 4.

In FIG. 4, the image search results 408 comprise multiple images arranged in an array comprising n rows 428 and m columns 430, with n=1 corresponding to the array's topmost row 428 and m=1 corresponding to the array's leftmost column 430. The image search results 408 are positioned in a window along the right and bottom edges of which extend scroll bars 418 that permit the user to scroll through the array. In FIG. 4, the array comprises at least 4×5 images, as that is the portion of the array that is visible without any scrolling using the scroll bars 418.

In the example embodiment shown in FIG. 4, each of the columns 430 of the image search results 408 corresponds to a different time period of the collection of video recordings. In the example of FIG. 4, each of the columns 430 corresponds to a three minute duration, with the leftmost column 430 representing search results 408 from 1:09 p.m. to 1:11 p.m., inclusively, the rightmost column 430 representing search results 408 from 1:21 p.m. to 1:23 p.m., inclusively, and the middle three columns 430 representing search results 408 from 1:12 p.m. to 1:20 p.m., inclusively. Additionally, in FIG. 4 each of the image search results 408 is positioned on the display 126 according to a likelihood that the image search result 408 corresponds to the person-of-interest 308. In the embodiment of FIG. 4, the video review application 144 implements this functionality by making the height of the image search result 408 in the array proportional to the likelihood that image search result 408 corresponds to the person-of-interest 308. Accordingly, for each of the columns 430, the search result 408 located in the topmost row 428 (n=1) is the search result 408 for the time period corresponding to that column 430 that is most likely to correspond to the person-of-interest 308, with match likelihood decreasing as n increases.

In an alternative embodiment, the image search results 408 may be displayed only in order of likelihood of correspondence to the person-of-interest.

In the depicted embodiment, all of the search results 408 satisfy a minimum likelihood that they correspond to the person-of-interest 308; for example, in certain embodiments the video review application 144 only displays search results 408 that have at least a 25% likelihood (“match likelihood threshold”) of corresponding to the person-of-interest 308. However, in certain other embodiments, the video review application 144 may display all search results 408 without taking into account a match likelihood threshold, or may use a non-zero match likelihood threshold that is other than 25%.

In FIG. 4, the body and face thumbnails 404, 402 include at least a portion of a first image 408a and a second image 408b, respectively, which include part of the image search results 408. The first and second images 408a,b, and accordingly the body and face thumbnails 404, 402, are different in FIG. 4; however, in different embodiments (not depicted), the thumbnails 404, 402 may be based on the same image. Overlaid on the first and second images 408a,b are a first and a second indicator 410a,b, respectively, indicating that the first and second images are the bases for the body and face thumbnails 404, 402. In FIG. 4 the first and second indicators 410a,b are identical stars, although in different embodiments (not depicted) the indicators 410a,b may be different.

Located immediately below the image frame 306 of the selected video recording are playback controls 426 that allow the user to play and pause the selected video recording. Located immediately above the horizontal scroll bar 418 beneath the image search results 408 is a load more results button 424, which permits the user to prompt the video review application 144 for additional search results 408. For example, in one embodiment, the video review application 144 may initially deliver at most a certain number of search results 408 even if additional results 408 exceed the match likelihood threshold. In that example, the user may request another tranche of results 408 that exceed the match likelihood threshold by selecting the load more results button 424. In certain other embodiments, the video review application 144 may be configured to display additional results 408 in response to the user's selecting the button 424 even if those additional results 408 are below the match likelihood threshold.

Located below the body and face thumbnails 404,402 is a filter toggle 422 that permits the user to restrict the image search results 408 to those that the user has confirmed corresponds to the person-of-interest 308 by having provided match confirmation user input to the video review application 144, as discussed further below.

Spanning the width of the page 300 and located below the body and face thumbnails 404, 402, search results 408, and image frame 306 is an appearance likelihood plot for the person-of-interest 308 in the form of a bar graph 412. The bar graph 412 depicts the likelihood that the person-of-interest 308 appears in the collection of video recordings over a given time span. In FIG. 4, the time span is divided into time periods of one day, and the entire time span is approximately three days (from August 23-25, inclusive). Each of the time periods is further divided into discrete time intervals, each of which is represented by one bar 414 of the bar graph 412. As discussed in further detail below, any one or more of the time span, time periods, and time intervals are adjustable in certain embodiments. The bar graph 412 is bookmarked at its ends by bar graph scroll controls 418, which allow the user to scroll forward and backward in time along the bar graph 412.

To determine the bar graph 412, the server system 108 determines, for each of the time intervals, a likelihood that the person-of-interest 308 appears in the collection of video recordings for the time interval, and then represents that likelihood as the height of the bar 414 for that time interval. In this example embodiment, the server system 108 determines that likelihood as a maximum likelihood that the person-of-interest 308 appears in any one of the collection of video recordings for that time interval. In different embodiments, that likelihood may be determined differently. For example, in one different embodiment the server system 108 determines that likelihood as an average likelihood that the person-of-interest 308 appears in the image search results 408 that satisfy the match likelihood threshold.

In FIG. 4, the first and second indicators 410a,b that the video review application 144 displays on the image search results 408 are also displayed on the bar graph 412 on the bars 414 that correspond to the time intervals during which the first and second images 408a,b are captured by the cameras 169, and on the timeline 320 at positions corresponding to those time intervals. This permits the user of the video review application 144 to quickly identify not only the images 408a,b used as the bases for the body and face thumbnails 404, 402, but to be visually presented in three different ways information on when those images 408a,b were captured. This may be particularly useful when neither the first image 408a nor second image 408b is currently shown on the display 126 (e.g., they may include part of the image search results 408 but require that the user scroll in order to see them) and therefore the indicators 410a,b are visible only on one or both of the bar graph 412 and timeline 320.

While in the depicted embodiment the appearance likelihood plot is shown as comprising the bar graph 412, in different embodiments (not depicted) the plot may take different forms. For example, the plot in different embodiments may include a line graph, with different points on the line graph corresponding to appearance likelihood at different time intervals, or use different colors to indicate different appearance likelihoods.

As in FIG. 3, the page 300 of FIG. 4 also includes the timeline 320, video control buttons 322, and video time indicator 324 extending along the bottom of the page 300.

The video review application 144 permits the user to provide match confirmation user input regarding whether at least one of the image search results 408 depicts the person-of-interest 308. The user may provide the match confirmation user input by, for example, selecting one of the image search results 408 to bring up a context menu (not shown) allowing the user to confirm whether that search result 408 depicts the person-of-interest 308. In response to the match confirmation user input, the server system 108 in the depicted embodiment determines whether any match likelihoods change and, accordingly, whether positioning of the image search results 408 is to be changed in response to the match confirmation user input. For example, in one embodiment when the user confirms one of the results 408 is a match, the server system 108 may use that confirmed image as a reference for comparisons when performing one or both of face and body searches. When the positioning of the image search results is to be changed, the video review application 144 updates the positioning of the image search results 408 in response to the match confirmation user input. For example, the video review application 144 may delete from the image search results 408 any result the user indicates does not contain the person-of-interest 308 and rearrange the remaining results 408 accordingly. In one example embodiment, one or both of the face and body thumbnails 402, 404 may change in response to the match confirmation user input. In another example embodiment, if the server system 108 is initially unable to identify any faces of the person-of-interest 308 and the video review application 144 accordingly does not display the face thumbnail 402, the server system 108 may be able to identify the person-of-interest's 308 face after receiving match confirmation user input and the video review application 144 may then show the face thumbnail 402.

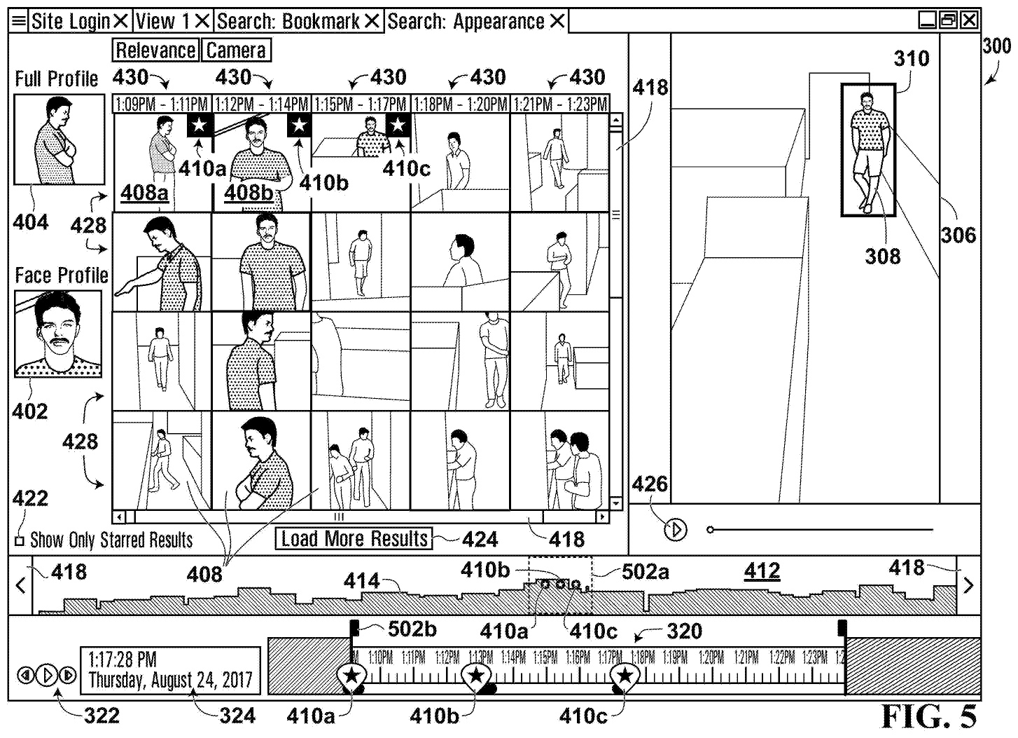

When the match confirmation user input indicates that any one of the selected image search results 408 depicts the person-of-interest 308, the video review application 144 displays a third indicator 410c over each of the selected image results 408 that the user confirms corresponds to the person-of-interest 308. As shown in the user interface page 300 of FIG. 5, which represents the page 300 of FIG. 4 after the user has provided match confirmation user input, the third indicator 410c in the depicted embodiment is a star and is identical the first and second indicators 410a,b. All three indicators 410a-c in FIG. 5 are in the three leftmost columns and the first row of the array of search results 408. In different embodiments (not depicted), any one or more of the first through third indicators 410a-c may be different from each other.

The page 300 of FIG. 5 also shows an appearance likelihood plot resizable selection window 502a and a timeline resizable selection window 502b overlaid on the bar graph 412 and the timeline 320, respectively. The user, by using the input device 114, is able to change the width of and pan each of the windows 502a,b by providing window resizing user input. As discussed in further detail below in respect of FIGS. 8A and 8B, the selection windows 502a,b are synchronized such that resizing one of the windows 502a,b such that it covers a particular time span automatically causes the video review application 144 to resize the other of the windows 502a,b so that it also covers the same time span. Additionally, the video review application 144 selects the image search results 408 only from the collection of video recordings corresponding to the particular time span that the selection windows 502a,b cover. In this way, the user may reposition one of the selection windows 502a,b and automatically have the video review application 144 resize the other of the selection windows 502a,b and update the search results 408 accordingly.

In FIGS. 8A and 8B, the user interface page 300 of FIG. 3 is shown with the resizable selection windows 502a,b selected to span a first duration (FIG. 8A, in which only a portion of the search results 408 for August 24th is selected) and a second, longer duration (FIG. 8B, in which substantially all of the search results 408 for August 24th are selected). As described above, the windows 502a,b in each of FIGS. 8A and 8B represent the same duration of time because the video review application 144, in response to the user resizing one of the windows 502a,b, automatically resizes the other. Additionally, the array of search results 408 the video review application 144 displays differs depending on the duration selected by the windows 502a,b, since the duration affects the portion of the collection of video recordings that may be used as a basis for the search results 408.

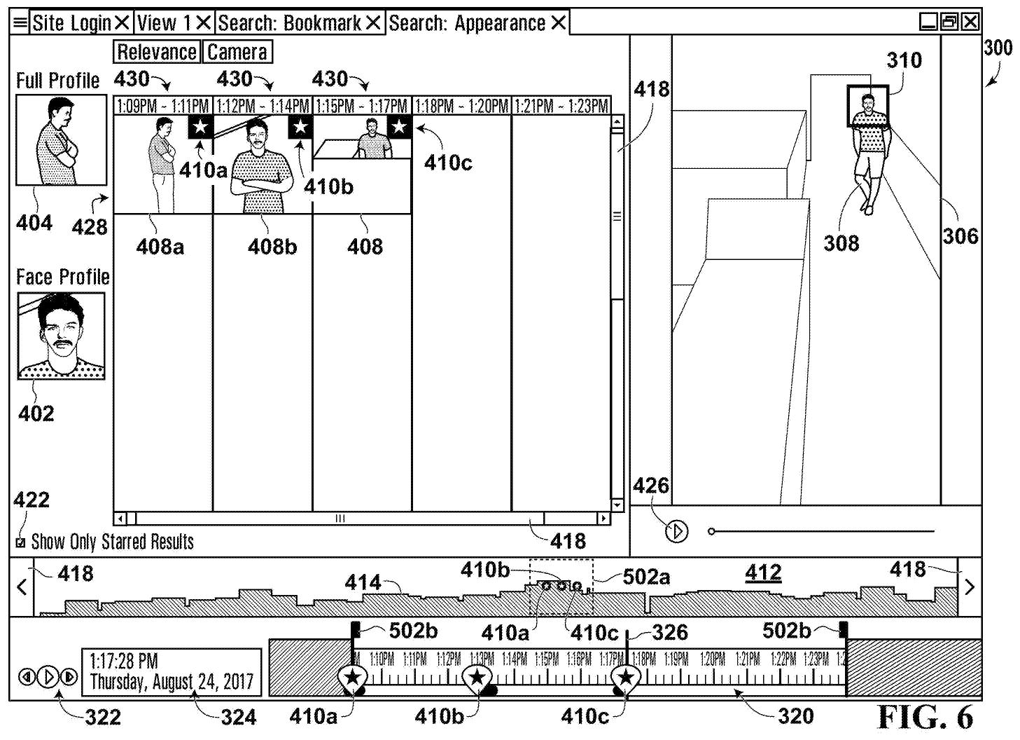

Referring now to FIG. 6, there is shown the user interface page 300 of FIG. 5 after the user has toggled the filter toggle 422 to limit the displayed search results 408 to those that the user has either provided match confirmation user input confirming that those search results 408 display the person-of-interest 308 and to those that are used as the bases for the face and body thumbnails 402,404. As mentioned above, the indicators 410a-c used to highlight the search results 408 in the array is also used to highlight in the bar graph 412 and the timeline 320 when those search results 408 were obtained.

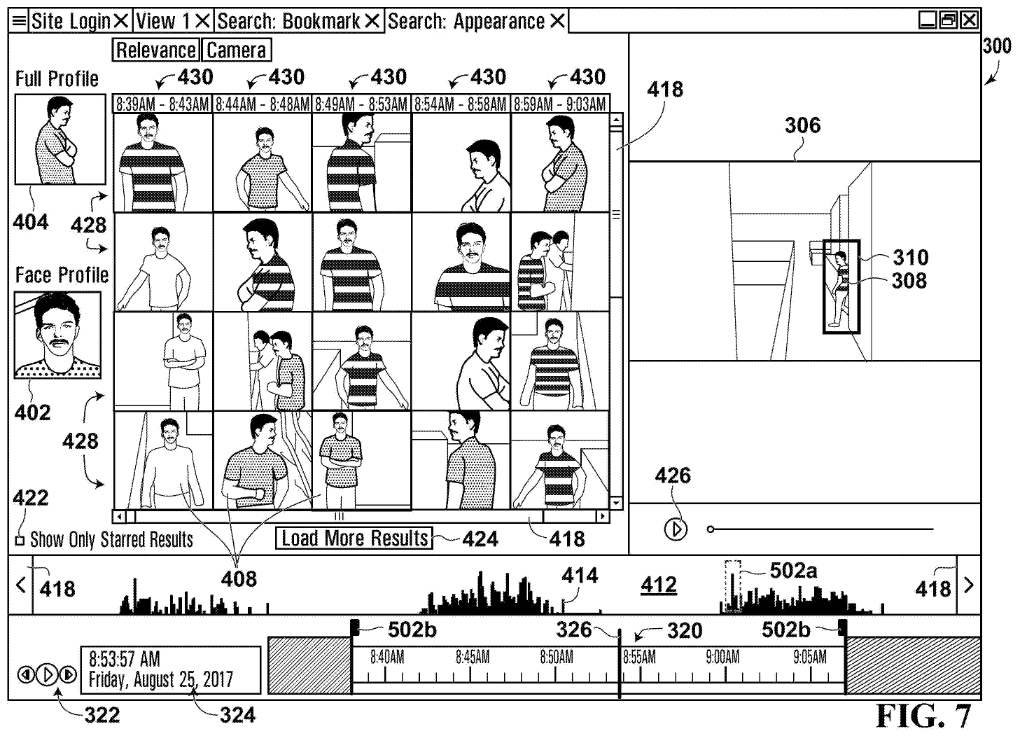

FIG. 7 shows a user interface page including the image search results 408, the face thumbnail 402, and the body thumbnail 404 of the person-of-interest 308, with the image search results 408 showing the person-of-interest 308 wearing different clothes than in FIGS. 3-6. In FIG. 7, the selection windows 502a,b have been adjusted so that the image search results are limited to images from August 25th, while the search results 408 depicted in FIGS. 3-6 are limited to images from August 24th. As mentioned above, the server system 108 in the depicted embodiment searches the collection of video recordings for the person-of-interest 308 using both face and body searches, with the body search taking into account the person-of-interest's 308 clothing. Incorporating the face search accordingly helps the server system 108 identify the person-of-interest 308, particularly when his or her clothing is different at different times within one or more of the collection of video recordings or is different across different recordings comprising the collection of video recordings. Because the person-of-interest 308 in the results of FIG. 7 is wearing different clothing than in FIGS. 3-6 and the appearance of his body has accordingly changed, the person-of-interest 308 shown in the image search results 408 of FIG. 7 (such as in the search results 408 in which the person-of-interest 308 is wearing a striped shirt) is accordingly identified primarily using the face search as opposed to the body search.

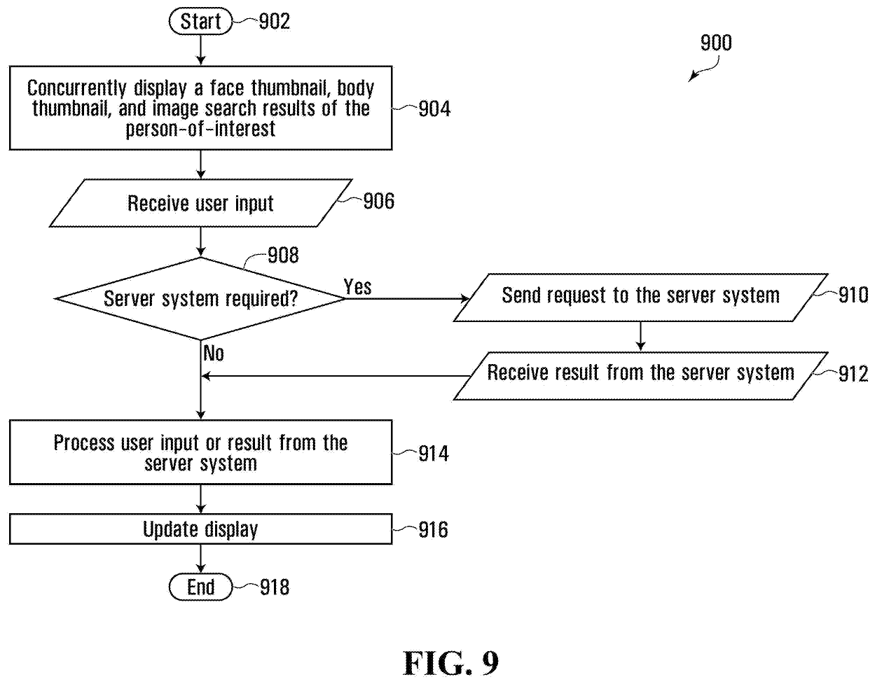

Referring now to FIG. 9, there is shown a method 900 for interfacing with the user to facilitate an image search for the person-of-interest 308, according to another example embodiment. The method 900 may be expressed as computer program code that implements the video review application 144 and that is stored in the computer terminal's 104 non-volatile storage 120. At runtime, the processor 112 loads the computer program code into the RAM 116 and executes the code, thereby performing the method 900.

The method 900 starts at block 902, following which the processor 112 proceeds to block 904 and concurrently displays, on the display 126, the face thumbnail 402, body thumbnail 404, and the image search results 408 of the person-of-interest 308.

The processor 112 proceeds to block 906 where it receives some form of user input; example forms of user input are the match confirmation user input and search commencement user input described above. Additionally or alternatively, the user input may comprise another type of user input, such as any one or more of interaction with the playback controls 426, the bar graph 412, and the timeline 320.

Following receiving the user input, the processor proceeds to block 908 where it determines whether the server system 108 is required to process the user input received at block 906. For example, if the user input is scrolling through the image search results 408 using the scroll bars 418, then the server system 108 is not required and the processor 112 proceeds directly to block 914 where it processes the user input itself. When processing input in the form of scrolling, the processor 112 determines how to update the array of image search results 408 in response to the scrolling and then proceeds to block 916 where it actually updates the display 126 accordingly.

In certain examples, the processor 112 determines that the server system 108 is required to properly process the user input. For example, the user input may include search commencement user input, which results in the server system 108 commencing a new search of the collection of video recordings for the person-of-interest 308. In that example, the processor 112 proceeds to block 910 where it sends a request to the server system 108 to process the search commencement user input in the form, for example, of a remote procedure call. At block 912 the processor 112 receives the result from the server system 108, which may include an updated array of image search results 408 and associated images.

The processor 112 subsequently proceeds to block 914 where it determines how to update the display 126 in view of the updated search results 408 and images received from the server system 108 at block 912, and subsequently proceeds to block 916 to actually update the display 126.

Regardless of whether the processor 112 relies on the server system 108 to perform any operations at blocks 910 and 912, a reference herein to the processor 112 or video review application 144 performing an operation includes an operation that the processor 112 or video review application 144 performs with assistance from the server system 108, and an operation that the processor 112 or video review application 144 performs without assistance from the server system 108.

After completing block 916, regardless of whether the processor 112 communicated with the server system 108 in response to the user input, the processor 112 proceeds to block 918 where the method 900 ends. The processor 112 may repeat the method 900 as desired, such as by starting the method 900 again at block 902 or at block 906.

Facet Search

In at least some example embodiments, the methods, systems, and techniques as described herein are adapted as described further below to search for an object-of-interest. An object-of-interest may comprise the person-of-interest 308 described above in respect of FIGS. 3 to 8B; additionally or alternatively, an object-of-interest may comprise a non-person object, such as a vehicle. More particularly, the server system 108 in at least some example embodiments is configured to perform a “facet search”, where a “facet” affects a particular visual characteristic of an object-of-interest. For example, when the server system 108 is being used to search for a person-of-interest, “facets” of that person-of-interest may comprise any one or more of that person's gender, that person's age, a type of clothing being worn by that person, a color of that clothing, a pattern displayed on that clothing, that person's hair color, that person's hair length, that person's footwear color, and that person's clothing accessories (such as, for example, a purse or bag).

The server system 108 in at least some example embodiments saves the facet in storage 190 as a data structure comprising a “descriptor” and a “tag”. The facet descriptor may comprise a text string describing the type of facet, while the facet tag may comprise a value indicating the nature of that facet. For example, when the facet is hair color, the facet descriptor may be “hair color” and the facet tag may be “brown” or another color drawn from a list of colors. Similarly, when the facet is a type of clothing, the facet descriptor may be “clothing type” and the facet tag may be “jacket” or another clothing type drawn from a list of clothing types.

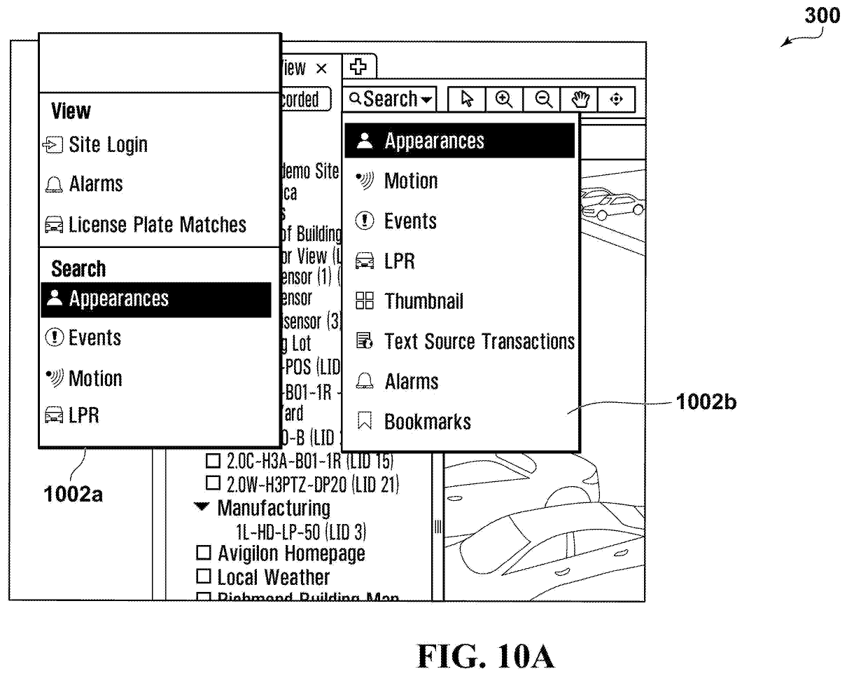

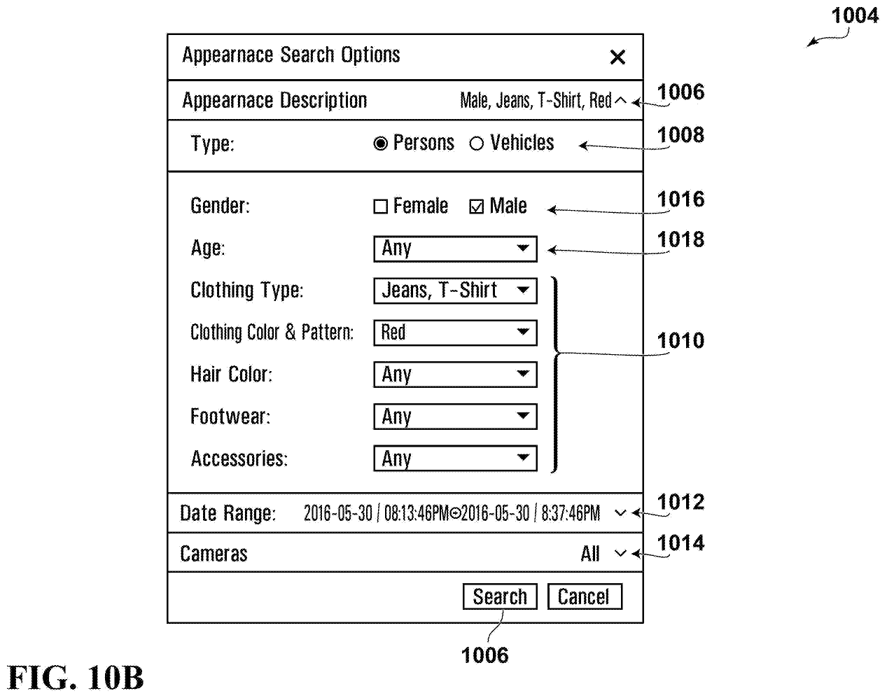

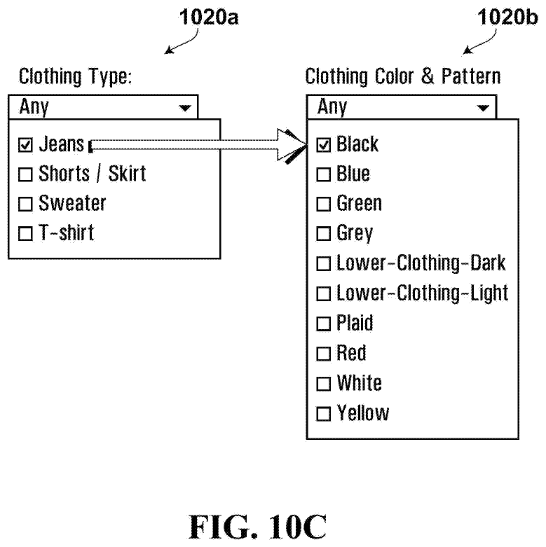

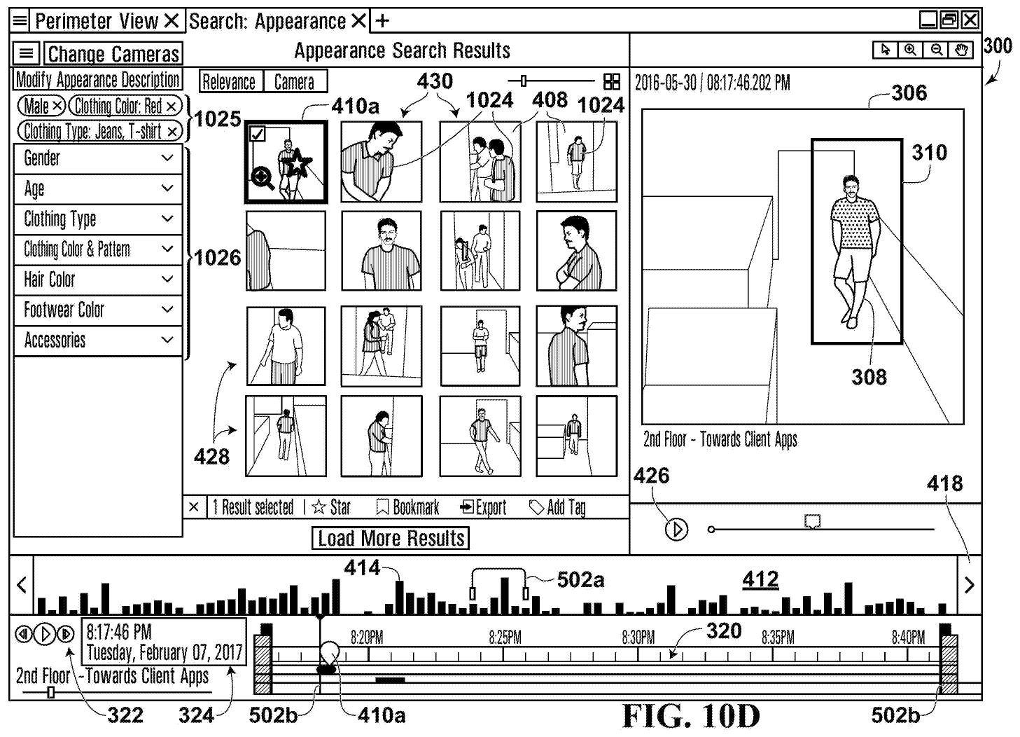

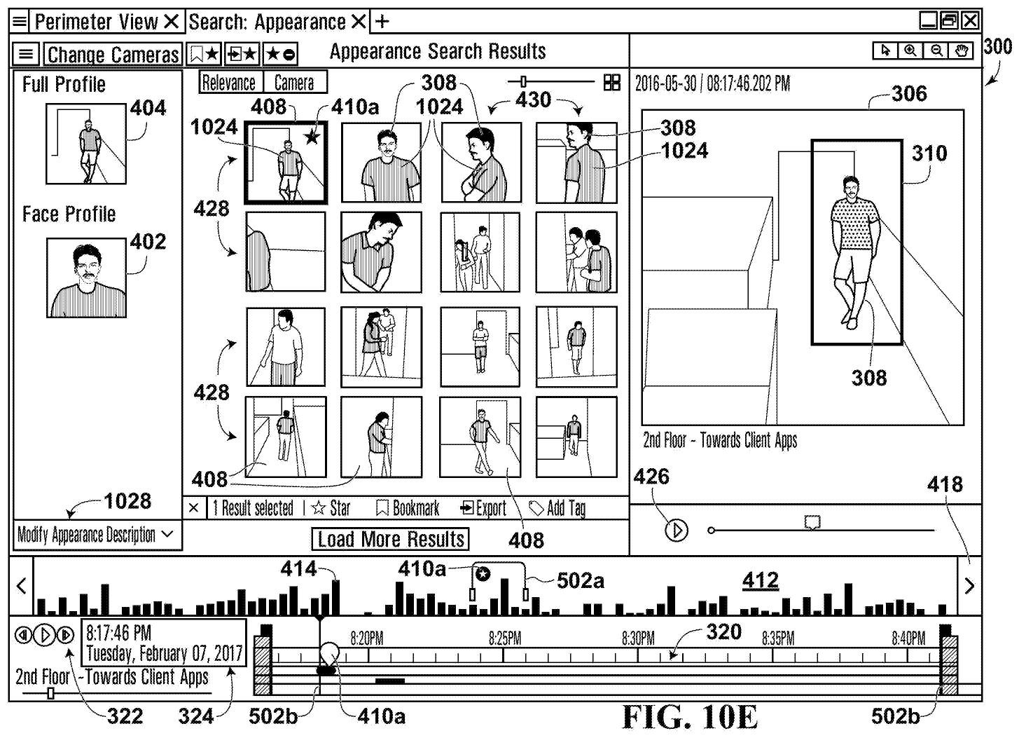

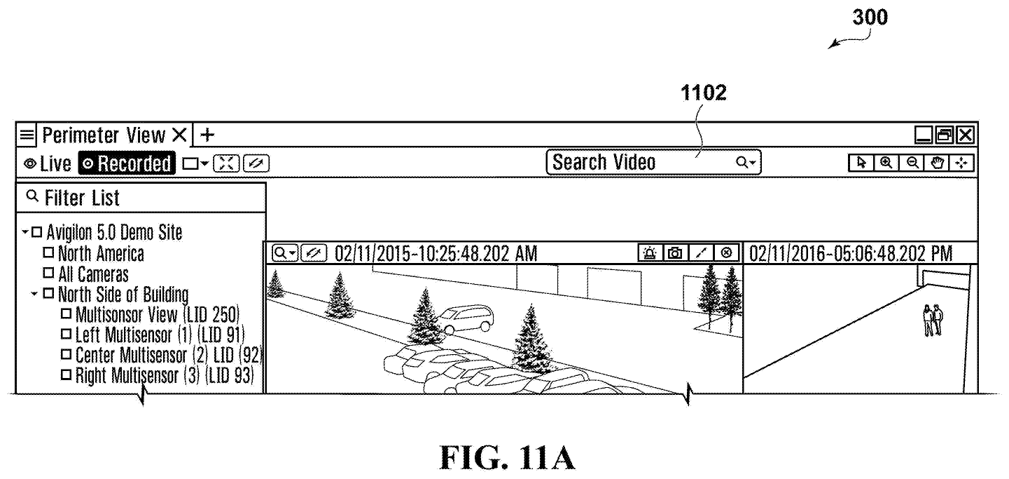

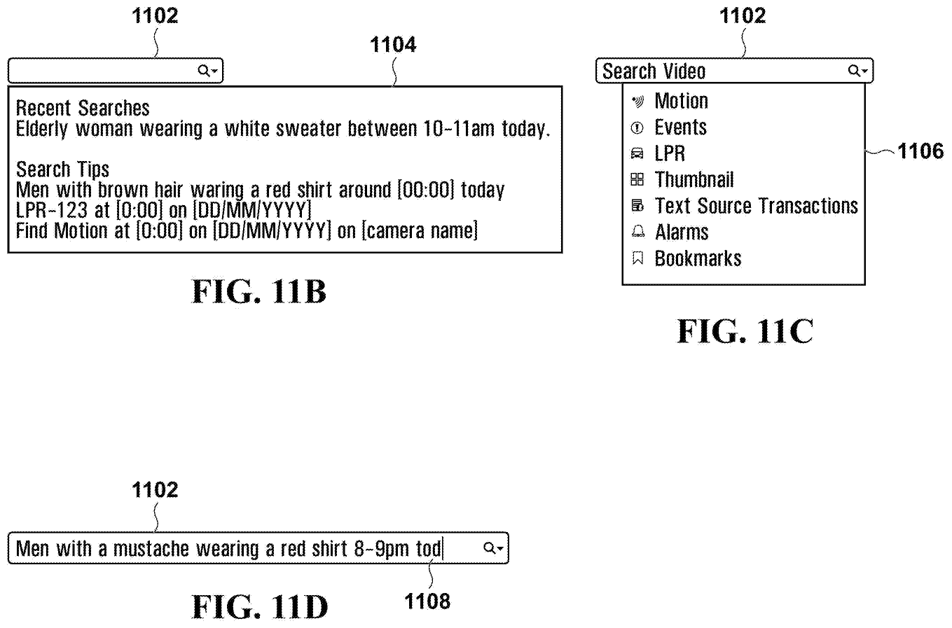

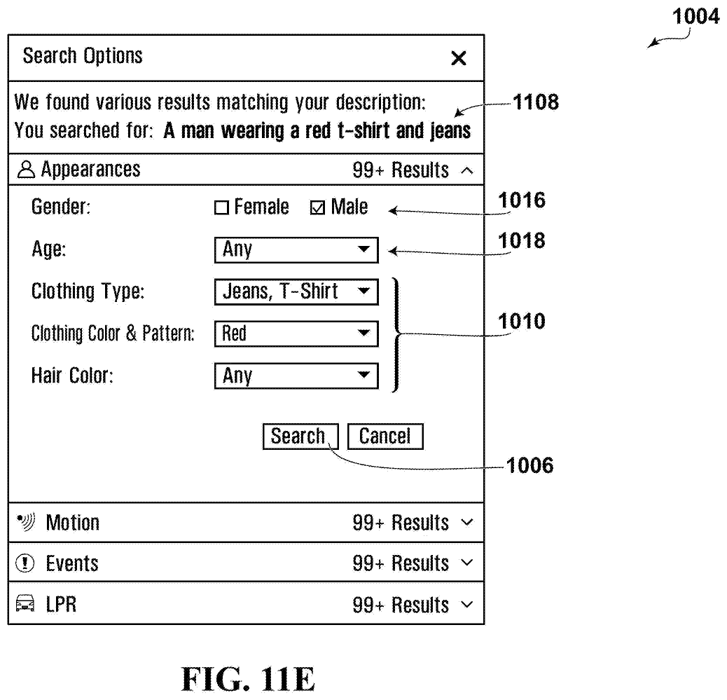

In at least some example embodiments and as described in respect of FIGS. 10A to 11E, the server system 108 is configured to permit a facet search to be done before or after an image search of the type described in respect of FIGS. 3 to 8B. In contrast to the “facet search” workflow depicted in FIGS. 10A to 11E, the image search described in respect of FIGS. 3 to 8B is hereinafter described as “body/face search”, as it is performed based on the person-of-interest's 308 body or face.

Referring now to FIGS. 10A-10E, there are depicted the user interface page 300 or portions thereof in various states while a facet search is being performed, according to at least one example embodiment. In FIG. 10A, the page 300 comprises a first search menu 1002a and a second search menu 1002b, either of which a user may interact with to commence a facet search. The first search menu 1002a is an example of a context menu while the second search menu 1002b is an example of a drop-down menu. The user may commence a facet search by selecting the “Appearances” option on either of the menus 1002a,b.

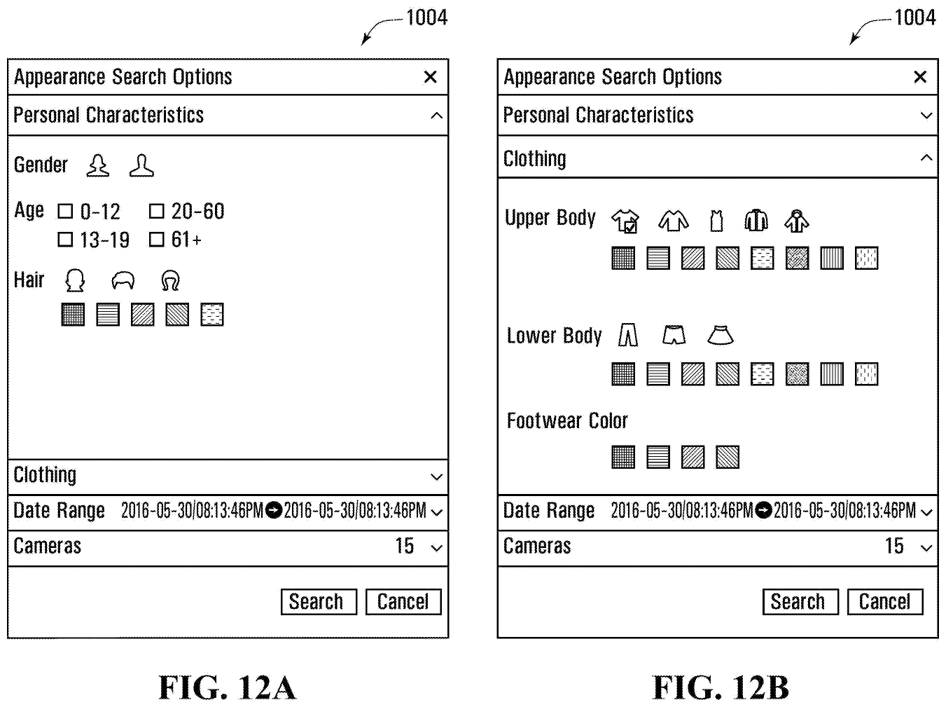

After selecting “Appearances” in FIG. 10A, the user interface displays a facet search menu 1004 as shown in FIG. 10B. The facet menu 1004 comprises an object-of-interest selector 1008, which in FIG. 10B are radio buttons allowing the user to select an object-of-interest in the form of a person (as selected in FIG. 10B) or a vehicle; various facet selectors in the form of a gender selector 1016, an age selector 1018, and various additional facet selectors 1010; a date range selector 1012, which allows the user to limit the facet search to a specified date range; a camera selector 1014, which allows the user to limit the facet search to particular, specified cameras; and a search button 1006 that, when selected by the user, comprises facet search commencement user input indicating that the facet search is to commence. In at least one different example embodiment, such as that depicted in FIGS. 12A and 12B, the facet search menu 1004 may graphically depict user-selectable images of different hairstyles, upper and lower body clothing types, and different colors to permit the user to select facet descriptors and/or tags. For example, in FIG. 12A the user may select facets such as gender, age, hair style, and/or hair color; and in FIG. 12B, the user may select facets such as upper body clothing type and color; lower body clothing type and color; and footwear color.

The facet selectors 1010, 1016, 1018 allow the user to adjust any one or more of the person-of-interest's 308 gender (selected in FIG. 10A to be male); age (not specified in FIG. 10A); clothing type (selected in FIG. 10A to comprise jeans and a T-shirt); clothing color and/or pattern (selected in FIG. 10A to be red); hair color (not specified in FIG. 10A); footwear color (not specified in FIG. 10A); and accessories (not specified in FIG. 10A) such as, for example, whether the person-of-interest 308 is holding a purse or wearing a hat. In different example embodiments (not depicted), more, fewer, or different facets than those listed in FIG. 10A may be selectable.

FIG. 10C depicts an example clothing type menu 1020a and an example clothing color and/or pattern menu 1020b, which are depicted as example additional facet selectors 1010 in FIG. 10B. The clothing type menu 1020a allows the user to select any one or more of jeans, shorts/skirt, a sweater, and a T-shirt as facets, and the clothing color and/or pattern menu 1020b allows the user to select any one or more of black, blue, green, grey, dark (lower clothing), light (lower clothing), plaid, red, white, and yellow facets as applied to the person-of-interest's 308 clothing. In at least some example embodiments, the lower clothing selectors of the color and/or pattern menu 1020b are only user selectable if the user has also selected lower body clothing in the clothing type menu 1020a. As shown in FIG. 10C, as the user has selected “jeans” in the clothing type menu 1020a, the user is then free to specify whether the jeans are light or dark in the color and/or pattern menu 1020b. In at least some different example embodiments, a user may select the facet tag (e.g., clothing's color and/or pattern) regardless of whether the facet descriptor has been selected. In the depicted example embodiment, the facet descriptor is “clothing type”, while the “facet tag” comprises the various colors and types in the drop-down menus 1020a,b.

In at least some different example embodiments (not depicted), the user interface may differ from that which is depicted. For example, instead of the text-based drop-down menus 1020a,b depicted in FIGS. 10B and 10C, the search UI module 202 may present the user with an array of user-selectable images representing the facets available to be searched, analogous to those displayed in FIGS. 12A and 12B. Additionally or alternatively, in at least some example embodiments the clothing type menu 1020a comprises at least one of “Upper Body Clothing” and “Lower Body Clothing”, with a corresponding at least one of “Upper Body Clothing Color” and “Lower Body Clothing Color” being depicted in the clothing color and/or pattern menu 1020.

In response to the facet search commencement user input that the user provides by selecting the search button 1006, the server system 108 searches one or more of the video recordings for the facets. The server system 108 may perform the searching using a suitably trained artificial neural network, such as a convolutional neural network as described above for the body/face search. The server system 108 displays, on the display, facet image search results depicting the facets, with the facet image search results being selected from the one or more video recordings that were searched. In at least the depicted example embodiment, the facet image search results depict the facet in conjunction with a common type of object-of-interest common to the image search results.

FIG. 10D shows a page 300 depicting the facet image search results using an interface that is analogous to that depicted in FIGS. 4-8B. Similar to the body/face search described above, the image search results 408 comprising the results are arranged in an array comprising n rows 428 and m columns 430, with images 408 that are more likely to depict the facets shown in higher columns than image search results 408 that are less likely to depict the facets. In contrast to the embodiments of FIGS. 4-8B, the different columns 430 into which the facet image search results do not correspond to different time periods; instead, the results in each row 428 of the results are ordered by confidence from left (higher confidence) to right (lower confidence). In FIG. 10D, the server system 108 searched for a person-of-interest in the form of a man wearing jeans and a T-shirt 1024, with the T-shirt 1024 being red, as summarized in a searched facets list 1025 and as specified by the user in the facet search menu 1004 depicted in FIG. 10B.

Each of the entries in the searched facet list 1025 displays an “X” that is user selectable, and that when selected by the user causes that entry in the searched facet list 1025 to disappear. Removing a facet from the searched facet list 1025 in this manner represents updated facet search commencement user input, and causes the server system 108 to update the facet image search results by searching for the updated list of facets. The results of this updated search are displayed in the n×m array of image search results 408. In at least some example embodiments, the act of removing a facet from the searched facet list 1025 in this manner is implemented by the server system 108 deleting the contents of a tag associated with the removed facet.

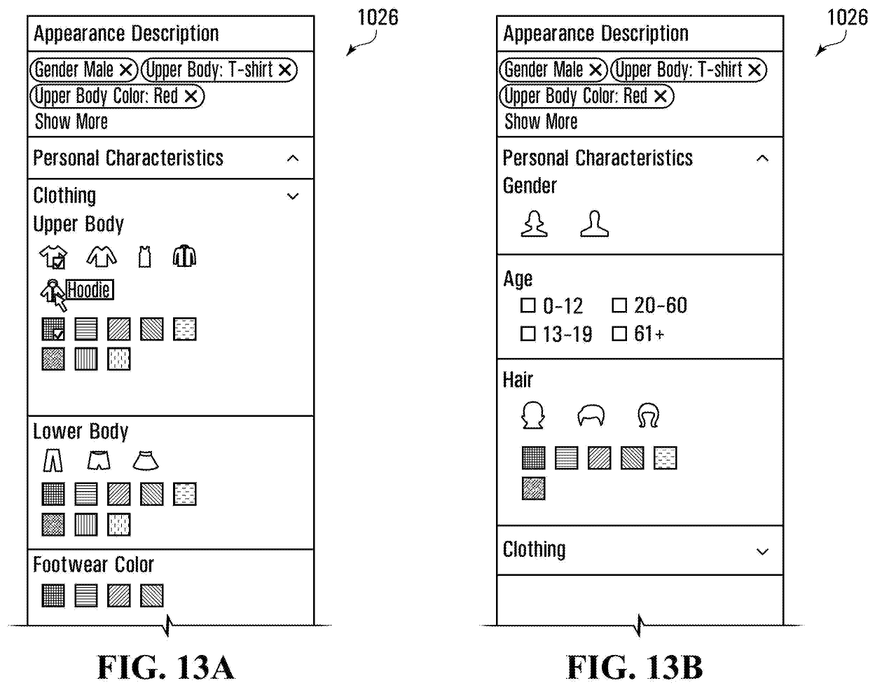

Below the searched facet list 1025 is a series of menus 1026 allowing the user to further revise the list of facets to be searched by adding or removing facets in a manner analogous to that described in respect of the facet search menu 1004 of FIG. 10B. Adding or removing facets in this manner is also an example of updated facet search commencement user input, and accordingly also causes the server system 108 to update the facet image search results by searching for the updated list of facets. While the menus 1026 of FIG. 10D comprise drop-down menus, in at least some different example embodiments, such as that depicted in FIGS. 13A and 13B, various user-selectable images depicting possible facets are presented to the user instead of drop-down menus.

The user may commence a body/face search directly from the page 300 of FIG. 10D. In FIG. 10D, the user may select the person-of-interest 308 who will be the subject of the body/face search, which in this case is in the first image 410a, and through a context menu (not shown in FIG. 10D) directly commence the body/face search for the person-of-interest 308. In this example, the server system's 108 receiving a signal from the user to commence the search through the context menu is an example of object-of-interest search commencement user input.

In response to that object-of-interest search commencement user input, the server system 108 searches the one or more video recordings for the object-of-interest. In at least some example embodiments, the search is not restricted to the one or more video recordings from which were selected the facet image search results; for example, the server system 108 may search the same video recordings that were searched when performing the facet search. In at least some other example embodiments, the one or more video recordings that are searched are the one or more video recordings from which the facet image search results were selected, and the object-of-interest search results are selected from those one or more video recordings. After the server system 108 performs the object-of-interest search, it displays, on the display, the object-of-interest search results. In at least some of those example embodiments in which the object-of-interest search is done on the video recordings that were also searched when performing the facet search, the object-of-interest search results depict the object-of-interest and the facet. The object-of-interest search results are depicted in the user interface page 300 of FIG. 10E, which is analogous to the pages 300 depicted in FIGS. 4-8B.

FIG. 10E also depicts a facet modification element 1028 that, when selected, brings up the searched facet list 1025 and menus 1026 of FIG. 10D to permit the user to modify and re-run the facet search, if desired. In at least some example embodiments, in response to a user's selecting the facet modification element 1028, the searched facet list 1025 and menus 1026 are brought up with showing the facet tags on which the depicted facet search results are based.

The object-of-interest search described immediately above is done after one or more facet searches. In at least some example embodiments, the object-of-interest search may be done before a facet search is done. For example, a body/face search may be done, and those image search results displayed, in accordance with the embodiments of FIGS. 4-8B. In at least some example embodiments, the server system 108 identifies facets appearing in those image search results, and displays, on the display, a list of those facets. The user then selects a facet comprising the list of facets, which represents facet search commencement user input. The server system 108 then searches the one or more video recordings from which are selected the object-of-interest search results for the facet, and subsequently displays facet search results that show the object-of-interest in conjunction with the facet.

Referring now to FIGS. 11A-11E, there are depicted the user interface page 300 or portions thereof in various states when a natural language facet search is being performed, according to another example embodiment. FIG. 11A depicts the page 300 comprising a natural language search box 1102 configured to receive a natural language text query from the user. The user may input the query using input devices such as a keyboard and/or a dictation tool. In at least some example embodiments, the natural language search processing engine may use any one or more of a context-free grammar parse tree, a dependency grammar parser, a probabilistic parser, and word embedding.

FIG. 11B shows a text box 1104 listing example natural language search queries that the server system 108 can process. One example query is “Elderly woman wearing a white sweater between 10-11 am today”, in which the object-of-interest is a person, and the facets are her age (elderly), her gender (woman), her type of clothing (a sweater), and her clothing's color (white). Another example query is “Man with brown hair wearing a red shirt around [00:00] today”, in which the object-of-interest is again a person, and the facets are his hair color (brown), his type of clothing (a shirt), and his clothing's color (red). The server system 108 further constrains the search with non-facet limitations, which in these two examples comprise time and date of the video recordings to be searched. FIG. 11D similarly depicts an example natural language search query for a, “Man with a mustache wearing a red shirt 8-9 pm tod[ay]”. In this example, the object-of-interest is a person, and the facets are his mustache, his type of clothing (shirt), and his color of clothing (red), with additional search constraints of time and date.

FIG. 11C depicts various data collections 1106 that may be searched in response to a natural language search query. In addition to video, the server system 108 may search any one or more of motion, events, license plates, image thumbnails, text, alarms, and bookmarks.

In at least some example embodiments, the server system 108 performs a facet search immediately after receiving queries of the type depicted in FIGS. 11B-11D. In at least some different example embodiments, the server system 108 first displays the facet search menu 1004 of FIG. 11E to the user in order to confirm the data the server system 108 harvested from the natural language search query. The facet search menu 1004 of FIG. 11E displays a search query 1108 verbatim, and the server system 108 sets the facet selectors 1010, 1016, 1018 according to how it interprets the query. The user may manually adjust the facet selectors 1010, 1016, 1018 as desired. The facet search menu 1004 also comprises the search button 1006, which, once selected, causes the server system 108 to perform the facet search as described above. In at least some different example embodiments such as the one depicted in FIGS. 12A and 12B discussed above, various user-selectable images depicting possible facets are presented to the user instead of drop-down menus shown in FIG. 11E.

The facet search as described above may be performed with an artificial neural network trained as described below. In at least some example embodiments, including the embodiments described below, the artificial neural network comprises a convolutional neural network.

In at least some example embodiments, training images are used to train the convolutional neural network. The user generates a facet image training set that comprises the training images by, for example, selecting images that depict a common type of object-of-interest shown in conjunction with a common type of facet. For example, in at least some example embodiments the server system 108 displays a collection of images to the user, and the user selects which of those images depict a type of facet that the user wishes to train the server system 108 to recognize. The server system 108 may, for example, show the user a set of potential training images, of which a subset depict a person (the object) having brown hair (the facet); the user then selects only those images showing a person with brown hair as the training images comprising the training set. Different training images may show different people, although all of the training images show a common type of object in conjunction with a common type of facet. The training images may comprise image chips derived from images captured by one of the cameras 169, where a “chip” is a region corresponding to portion of a frame of a selected video recording, such as that portion within a bounding box 310.

Once the facet image training set is generated, it is used to train the artificial neural network to classify the type of facet depicted in the training images comprising the set when a sample image comprising that type of facet is input to the network. An example of a “sample image” is an image comprising part of one of the video recordings searched after the network has been trained, such as in the facet search described above. During training, optimization methods (such as stochastic gradient descent), and numerical gradient computation methods (such as backpropagation) are used to find the set of parameters that minimize the objective function (also known as a loss function). A cross entropy function is used as the objective function in the depicted example embodiments. This function is defined such that it takes high values when it the current trained model is less accurate (i.e., incorrectly classifies facets), and low values when the current trained model is more accurate (i.e., correctly classifies facets). The training process is thus reduced to a minimization problem. The process of finding the most accurate model is the training process, the resulting model with the set of parameters is the trained model, and the set of parameters is not changed once it is deployed. While in some example embodiments the user generates the training set, in other example embodiments a training set is provided to the artificial neural network for training. For example, a third party may provide a training set, and the user may then provide that training set to the artificial neural network.

During training, the server system 108 records state data corresponding to different states of the convolutional neural network during the training. In at least some example embodiments, the state data is indexed to index data such as at least one of the common type of facet depicted in the training images, identification credentials of a user who is performing the training, the training images, cameras used to capture the training images, timestamps of the training images, and a time when the training commenced. This allows the state of the convolutional neural network to be rolled back in response to a user request. For example, the server system 108 in at least some example embodiments receives index data corresponding to an earlier state of the network, and reverts to that earlier state by loading the state data indexed to the index data for that earlier state. This allows network training to be undone if the user deems it to have been unsuccessful. For example, if the user determines that a particular type of facet is now irrelevant, the network may be reverted to an earlier state prior to when it had been trained to classify that type of facet, thereby potentially saving computational resources. Similarly, a reversion to an earlier network state may be desirable based on time, in which case the index data may comprise the time prior to when undesirable training started, or on operator credentials in order to effectively eliminate poor training done by another user.

Certain adaptations and modifications of the described embodiments can be made. For example, with respect to either the client-side video review application 144 (FIGS. 1 and 2), these have been herein described as packaged software installed on the computer terminal 104; however in some alternative example embodiments implementation of the UI can be achieved with less installed software through the use of a web browser application (e.g. one of the other applications 152 shown in FIG. 1). A web browser application is a program used to view, download, upload, surf, and/or otherwise access documents (for example, web pages). In some examples, the browser application may be the well-known Microsoft® Internet Explorer®. Of course other types of browser applications are also equally possible including, for example, Google® Chrome™. The browser application reads pages that are marked up (for example, in HTML). Also, the browser application interprets the marked up pages into what the user sees rendered as a web page. The browser application could be run on the computer terminal 104 to cooperate with software components on the server system 108 in order to enable a computer terminal user to carry out actions related to providing input in order to facilitate identifying same individuals or objects appearing in a plurality of different video recordings. In such circumstances, the user of the computer terminal 104 is provided with an alternative example user interface through which the user inputs and receives information in relation to the video recordings.

Map Integration

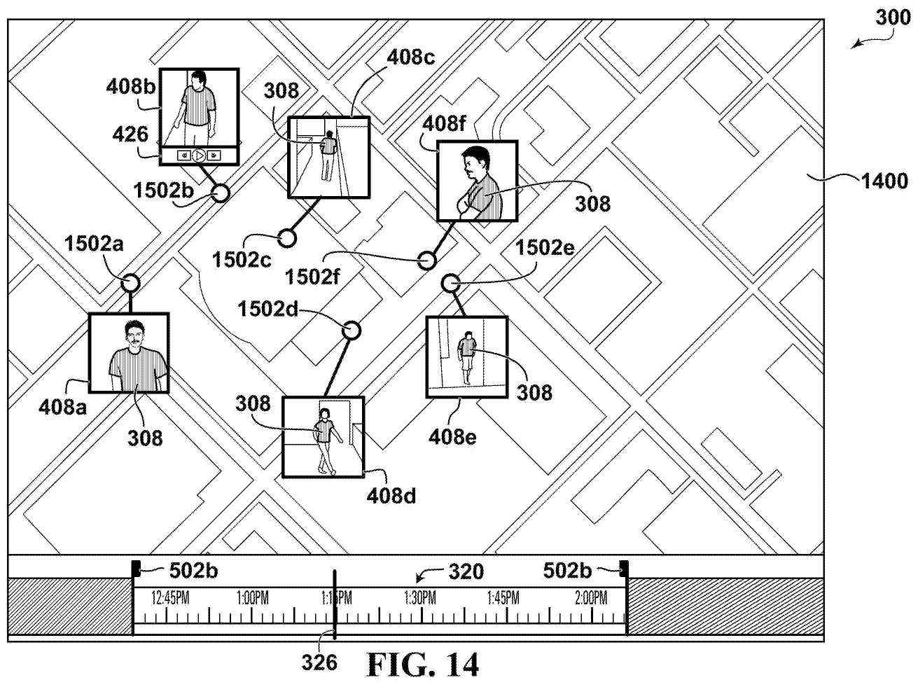

In the example embodiments of FIGS. 4-8B, 10D, and 10E, the user interface page 300 displays the image search results 408 in an array of rows 428 and columns 430. The search results 408 are not visually associated with a position on a map. In the example embodiments of FIGS. 14-17B, the image search results 408 are displayed in conjunction with a map. More particularly, the page 300 concurrently displays the search results 408 and a map on the display 126, and in at least some example embodiments the image search results 408 are overlaid on the map. Displaying the search results 408 in conjunction with a map allows the user to easily associate each of the search results 408 with a location corresponding to where the result 408 was obtained. Additionally, in at least some example embodiments, in addition to the map indicating where the search results 408 were obtained, the search results 408 may also appear sequentially on the display 126 in conjunction with the map. This quickly and intuitively indicates to the user the relative order in which the search results 408 were obtained.

Referring now to FIG. 14, there is depicted a user interface page 300 that the search UI module 202 displays to a user of the client-side video review application 144. The user interface page 300 displays various image search results 408 in conjunction with a map 1400, according to another example embodiment. More particularly, the user interface page 300 shown in FIG. 14 comprises a rectangular map 1400, on the underside of which is the timeline 320 and the resizable selection window 502b as described above. The map 1400 is of several city blocks with streets and the outlines of various buildings visible; however, in at least some other example embodiments (not depicted), different types of maps 1400 may be used. For example, in at least some different example embodiments the map 1400 may have a different resolution and depict several cities or countries concurrently. As another example, the map 1400 may be of the interior of a building, and depict various rooms and/or floors of the building. As another example, the map 1400 may be non-rectangular (e.g., circular or square). Map 1400 may be any virtual representation of the physical or logical relationship among sensors, such as cameras 169, and may be an abstract form, for example a hexagonal or lined display. An example of map 1400 could be a virtual annunciator panel used in intrusion/fire systems.

The user interface page 300 of FIG. 14 may be displayed in lieu of the page 300 of FIG. 4, for example, after the server system 108 has completed a search for the person-of-interest 308. More particularly, the server system 108 may receive search commencement input requesting that an appearance search for one or more objects-of-interest commence. This search commencement input may be in any suitable form, such as by the user selecting the context menu 312 of FIG. 3, or various other context menus 312 as discussed in further detail below. The search commencement input may additionally or alternatively be in a different form, such as a keyboard, touchscreen, and/or voice input via one of the input devices 114.

In response to the search commencement user input, the server system 108 searches one or more video recordings for the one or more objects-of-interest. After the server system 108 has performed the appearance search, it causes to be displayed, in conjunction with the map 1400 on the display 126, one or more of the image search results 408 depicting the one or more objects-of-interest. Each of the image search results 408 depicts the one or more objects-of-interest as captured by a camera 169 at a time during the one or more video recordings, and is depicted in conjunction with the map 1400 at a location indicative of a geographical location of the camera 169.

In the particular example embodiment of FIG. 14, the object-of-interest that is searched is an individual (i.e., a person-of-interest 308), and the image search results 408 are overlaid on the map 1400. Six different search results 408a-f are displayed, each of the same person-of-interest 308. The six different search results 408a-f are obtained using cameras 169 located at six different geographical camera locations 1502a-f, respectively, with each of the locations 1502 marked by an indicator in the form of a circle on the map 1400. Each of the first and third through sixth search results 408a,c-f is a still image; the second search result 408b is a video recording of the person-of-interest 308. The second search result 408b accordingly comprises playback controls 426, which in FIG. 14 are underneath and adjacent the video recording, to permit the user to play back the video recording. Through the playback controls 426, the user may play the video recording comprising the second search result 408b back while the other search results 408a,d-f are concurrently displayed.

While the locations 1502 are indicated on the map using circular icons, in at least some different example embodiments different icons may be used. For example, each of the icons may depict a camera 169. In order to populate the locations 1502 on the map 1400, the user may drag and drop icons representing each of the cameras 169 on to the map 1400 at their respective locations 1502, and also orient those icons such that they are oriented in a manner that corresponds to the actual cameras 169 deployed in the field.

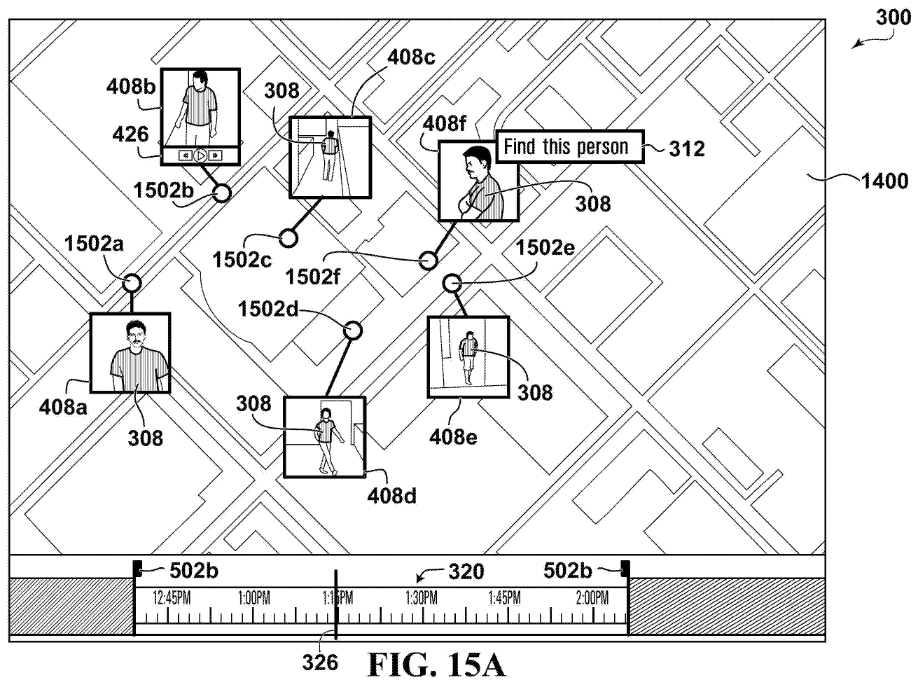

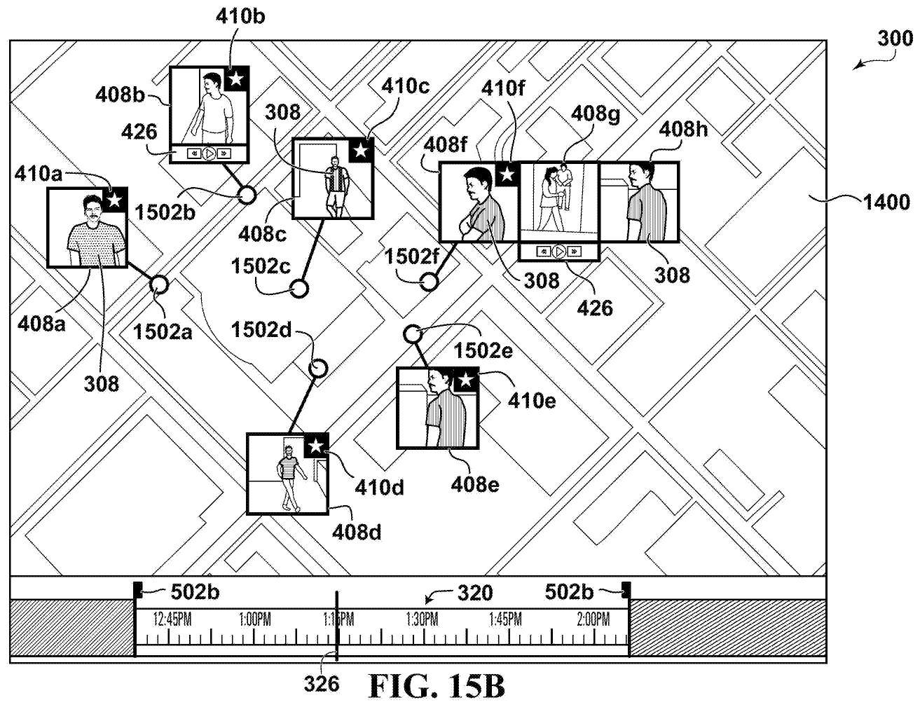

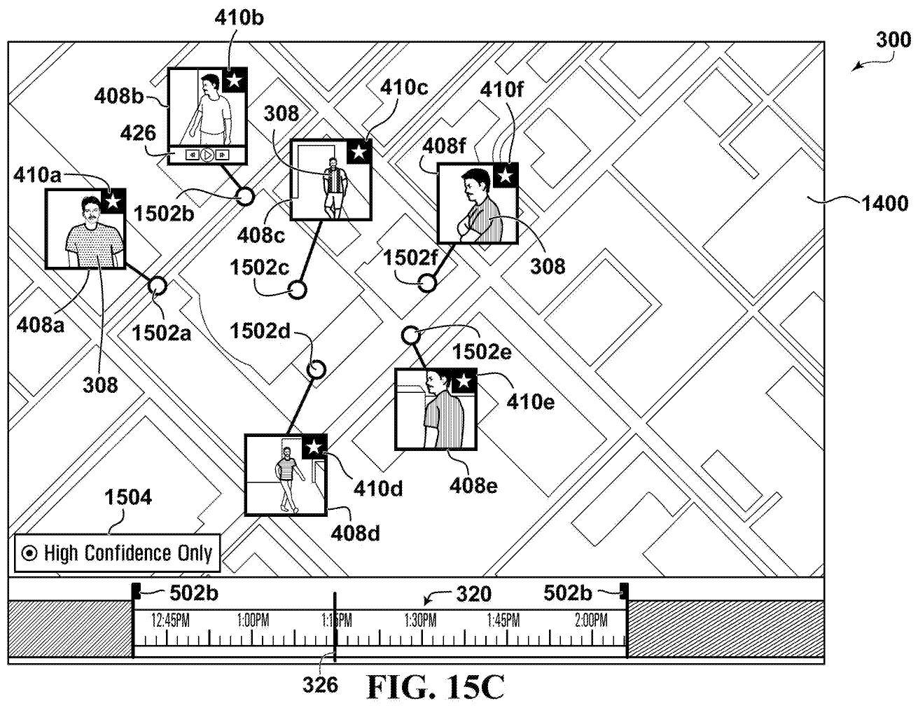

Referring now to FIG. 15A, there is shown a context menu 312 that overlays a portion of the map 1400 and the sixth search result 408f. The context menu 312 recites “Find this person” and permits the user to provide search commencement user input, which when provided instructs the server system 108 to commence another appearance search for the person-of-interest 308 depicted in that particular search result 408f; in this example embodiment, the search is performed on one or more video recordings for a single person-of-interest 308 regardless of that person-of-interest's 308 facets. This may be useful, for example, when the search results 408 depict different persons, and the user wishes to search the video recordings for only one of those particular persons. Additionally or alternatively, this may be useful when the scope of available video recordings changes, and the user wishes to repeat the search for a person-of-interest 308 for whom a search has already been conducted and who is depicted in one of the search results 406 already.

Referring now to FIG. 15B, there is shown the user interface page 300 of FIG. 15A following completion of the appearance search by the server system 108. The page 300 of FIG. 15B depicts eight search results 408a-h. The second and seventh results 408b,g comprise video recordings, and accordingly also comprise playback controls 426 beneath the video recordings. The remaining search results 408a,c-f,h are still images, with the first through fifth results 408a-e obtained using cameras 169 located at the first through fifth camera locations 1502a-e, respectively. The sixth through eighth results 408f-h are obtained using the camera 169 at the sixth camera location 1502f.

In FIG. 15B, the first through sixth and eighth results 408a-f,h actually depict the person-of-interest 308, while the seventh result 408g depicts a false positive; i.e., a person the server system 108 has identified as the person-of-interest 308 but who is in fact someone else. After reviewing the search results 408 the user elects to mark each of the first through sixth results 408a-f, using one or more of the input devices 114, with indicators 410a-f indicating that the user has high confidence that those results 408a-f actually depict the person-of-interest 308. In at least some example embodiments, the server system 108 may use the indicators 410a-f as feedback to train the artificial neural network used to generate the search results 408 so as to improve the accuracy of future searches.

In FIG. 15C, the user has selected a confidence selector 1504 in the form of a radio button that is displayed on the page 300 to indicate that the user desires to see only those results that the user has marked with one of the indicators 410a-f, thereby confirming with high confidence that the marked results 408a-f in fact depict the person-of-interest 308 for whom the user is searching. The search UI module 202 accordingly updates the page 300 of FIG. 15C to show only those results 408a-f that the user has marked with the indicators 410a-f.

The confidence selector 1504 is an example type of confidence level input specifying that only results 408a-f that are at or above that minimum confidence level are to be displayed. While a single “high” confidence level is used in FIG. 15C, in at least some different example embodiments (not depicted) different confidence levels associated with different indicators 410 may be used, and the confidence selector 1504 may accordingly permit selection of one or more corresponding minimum confidence levels.

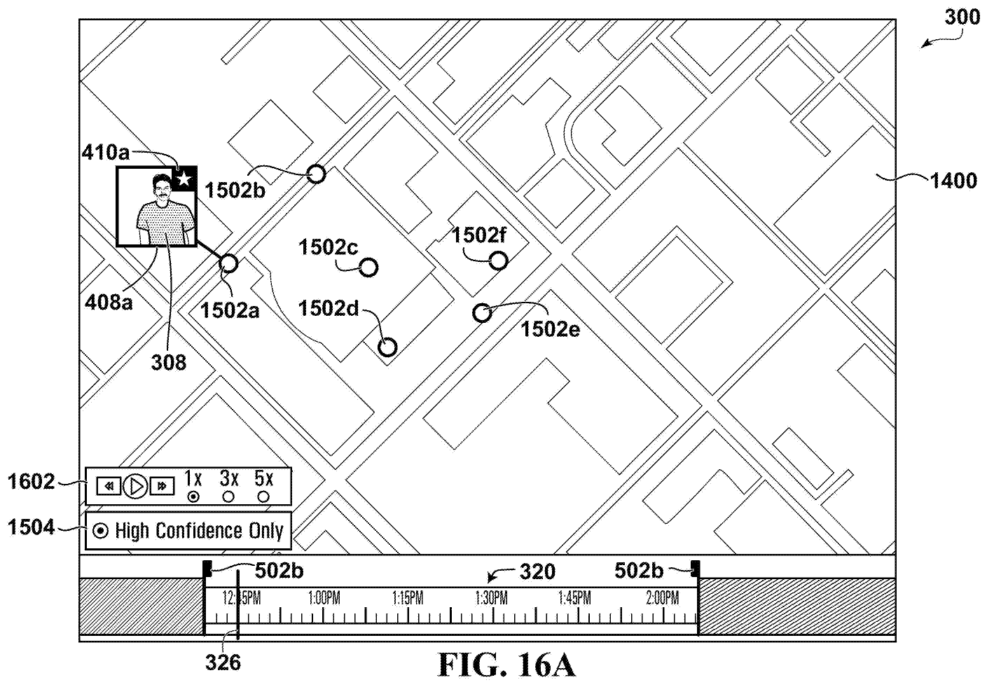

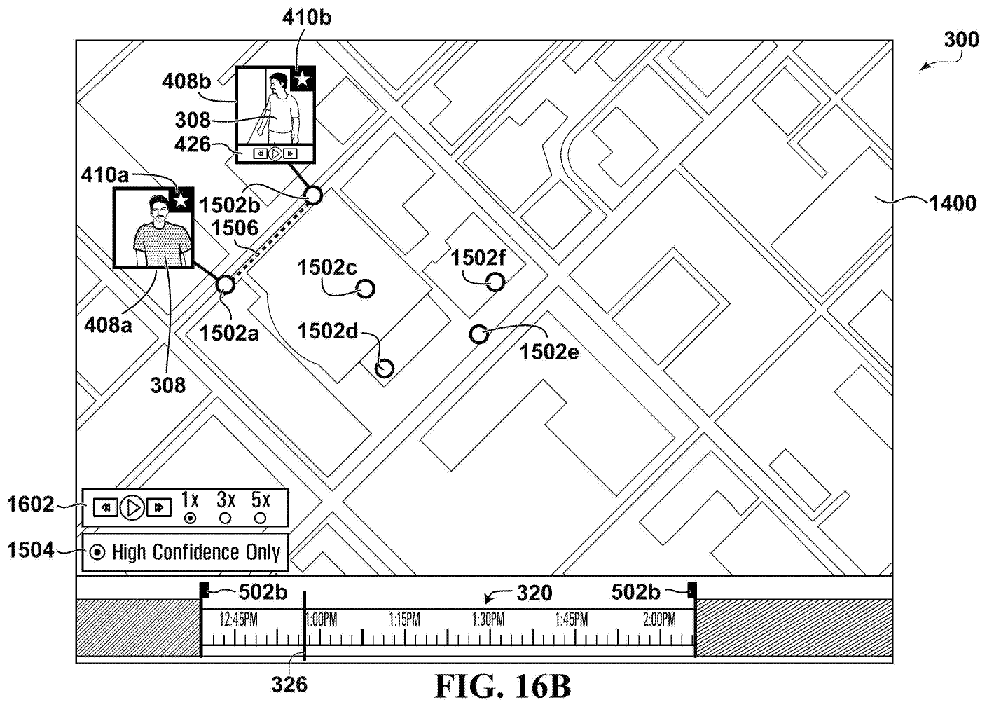

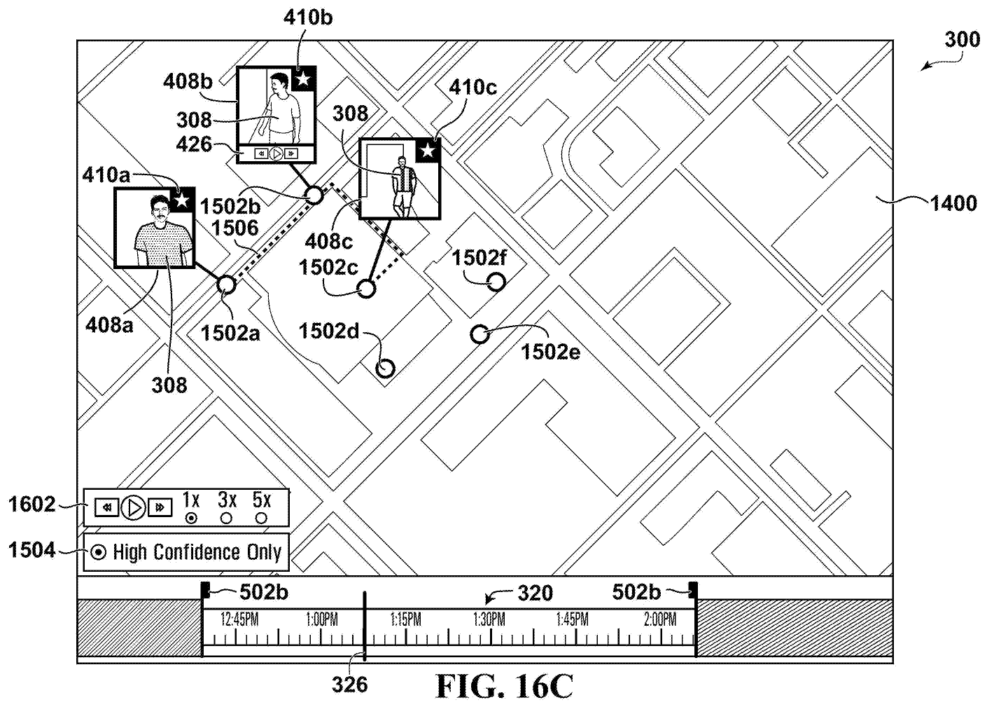

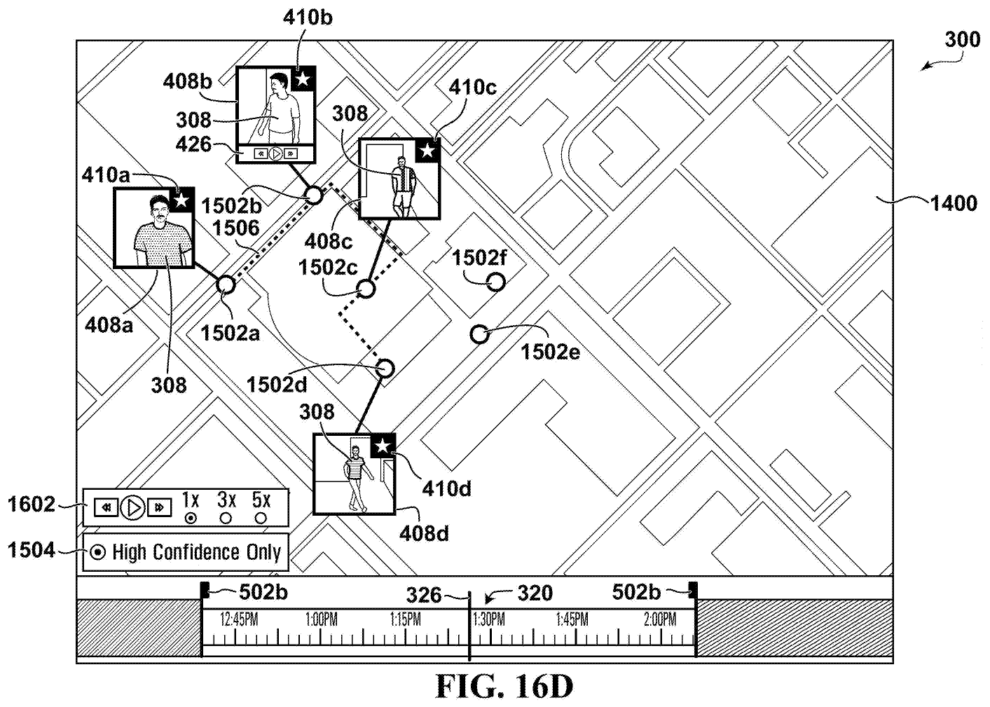

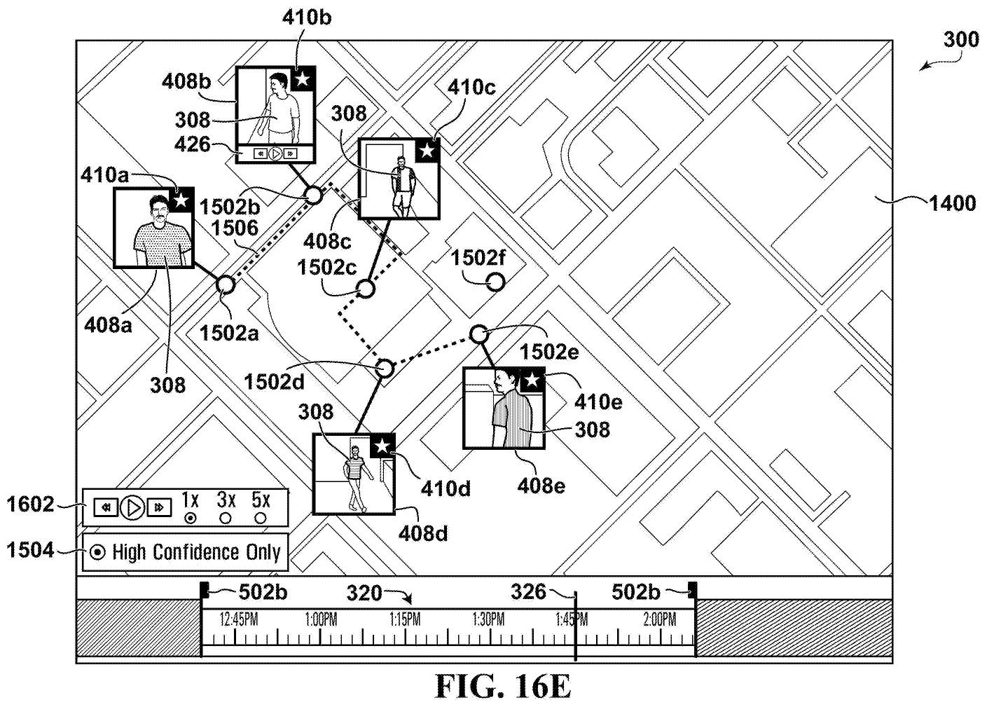

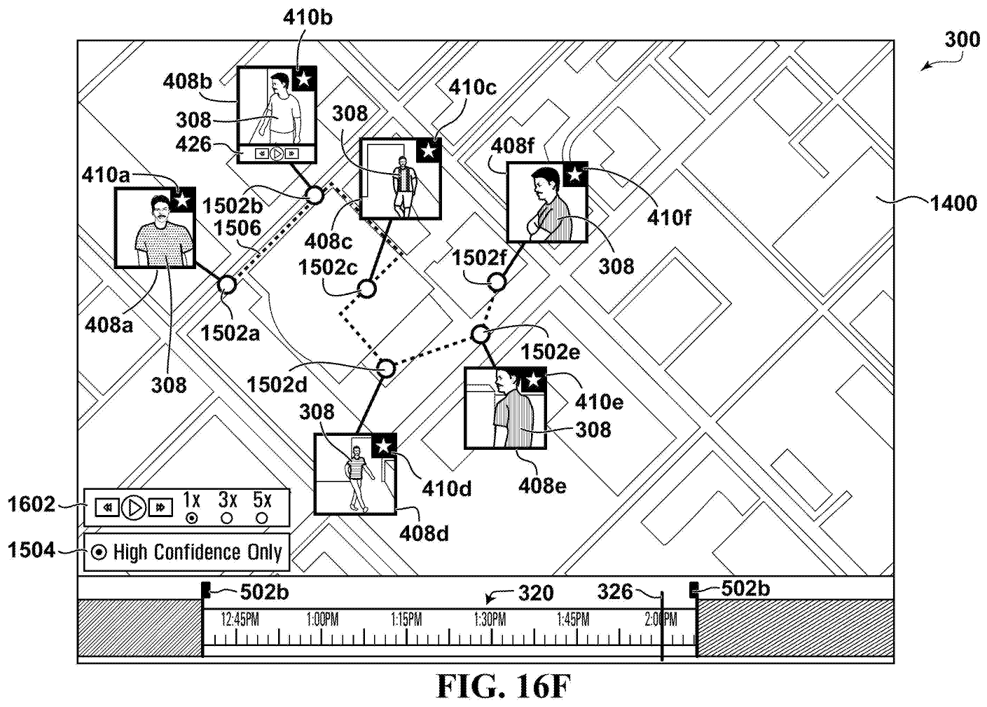

In at least some example embodiments, the search UI module 202 may update the page 300 over time to graphically indicate to the user when the search results 408 were obtained relative to each other; that is, the search results 406 may appear in an order corresponding to a sequence in which the results appear in the one or more video recordings. This may permit the user to, for example, track the path the person-of-interest 308 is traveling over time. FIGS. 16A-16F depict an example embodiment of this feature using the high confidence search results 408a-f of FIG. 15C.

Each of the pages 300 of FIGS. 16A-16F comprises search result playback controls 1602, which themselves comprise a play/pause selector and a playback speed selector that allows the user to cause the search results 408 to appear on the map 1400 in real-time (1×), or faster than real-time (3× or 5×). In different example embodiments (not depicted), the speed selector may cause the results to appear at some other multiple of real-time, such as less than 1×. The search results 406 may accordingly appear on the page 300 at times proportional to when the search results 406 appear in the one or more video recordings. The play/pause selector also enables the user to cause the search results 408 to fast forward or fast reverse through the search results 408.

In FIG. 16A, the user scrolls through the search results 408 by selecting the cursor 326 in the timeline 320 and moving it to 12:45 PM. At 12:45 PM, only the first search result 408a has appeared in the searched video recordings, and consequently only the first search result 408a appears on the page 300 in association with the first camera location 1502a. Following this, the user selects “play” at 1× playback from the playback controls 1602 to begin sequential playback of the search results 408; by selecting “play” at 1× playback, the search UI module 202 and/or the server system 108 receive playback input indicating that the search results 406 are to appear on the page 300. Only after that playback input is received is the page 300 updated such that the second through sixth results 408b-f appear, with the times at which those results 406 appear being adjusted in proportion to the playback speed. More particularly, subsequently in FIG. 16B the second search result 408b appears in association with the second camera location 1502b as it was obtained between 12:45 PM and 1:00 PM; in FIG. 16C the third search result 408c appears in association with the third camera location 1502c as it was obtained between 1:00 PM and 1:15 PM; in FIG. 16D the fourth search result 408d appears in association with the fourth camera location 1502d as it was obtained between 1:15 PM and 1:30 PM; in FIG. 16E the fifth search result 408e appears in association with the fifth camera location 1502e as it was obtained at 1:45 PM; and then in FIG. 16F the sixth search result 408f appears in association with the sixth camera location 1502f as it was obtained at 2:00 PM. Additionally, the search UI module 202 generates and depicts a path 1506 on the page 300 linking the locations 1502a-f associated with sequentially appearing results 408a-f. Namely, a first segment of the path 1506 is shown in FIG. 16B linking the first and second locations 1502a,b; a second segment of the path 1506 is added in FIG. 16C linking the second and third locations 1502b,c; a third segment of the path 1506 is added in FIG. 16D linking the third and fourth locations 1502c,d; a fourth segment of the path 1506 is added in FIG. 16E linking the fourth and fifth locations 1502d,e; and a fifth segment of the path 1506 is added in FIG. 16F linking the fifth and sixth locations 1502e,f. In at least the depicted example embodiment, the second and third segments of the path 1506 are not simply a single straight line that respectively connects the second and third locations 1502b,c and the third and fourth locations 1502c,d. Rather, the search UI module 202 accesses and uses metadata identifying walking paths and building entrances and exits, and ensures those segments pass through the entrances and/or exits of a building in which the third location 1502c is located on the presumption that the person-of-interest 308 uses them to enter and leave that building. The segment of the path 1506 connecting the second and third locations 1502b,c accordingly comprises three shorter segments that follow the periphery of that building to that building's entrance from which that segment proceeds directly to the third location 1502c. Similarly, the segment of the path 1506 connecting the third and fourth locations 1502c,d proceeds through an identified exit of that building, as opposed to being the shortest segment possible to connect those locations 1502c,d.

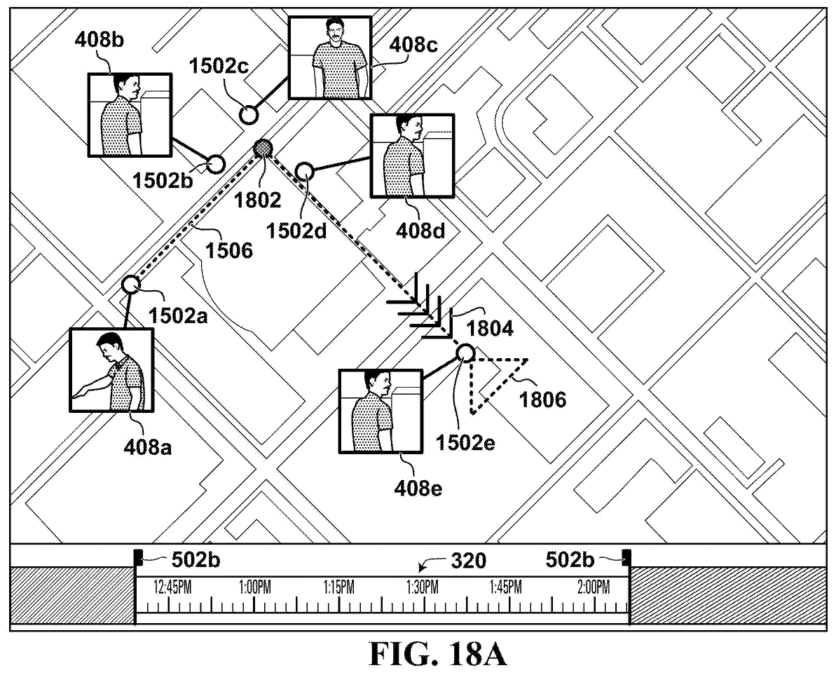

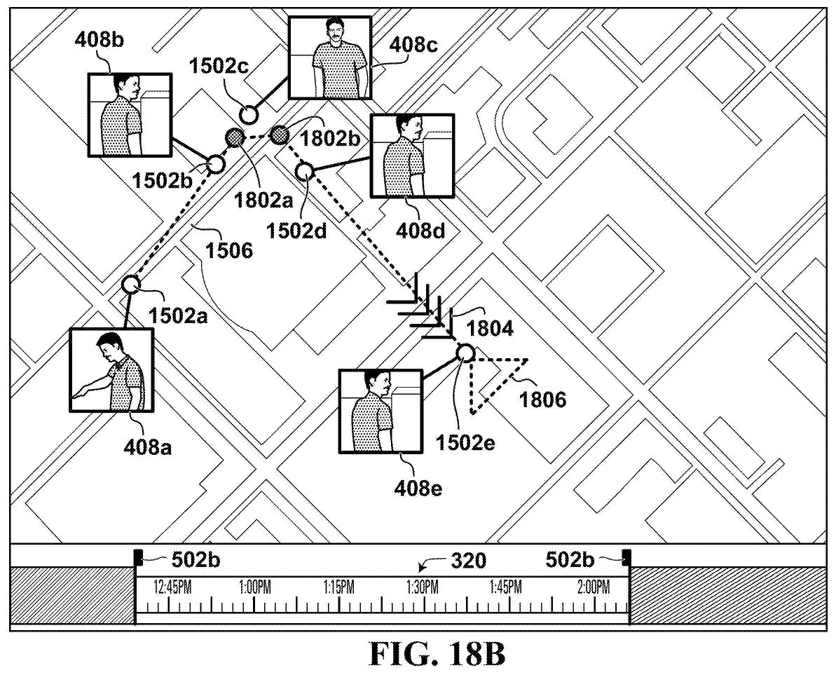

As described above, the path 1506 may comprise a series of linear line segments that connect locations 1502 corresponding to sequentially obtained search results 408. The path 1506 may be determined differently in at least some example embodiments; for example, multiple search results 408 may be averaged, and a line segment may terminate at a location on the map 1400 corresponding to that average as opposed to any single one of the camera locations 1502. FIGS. 18A and 18B depict additional embodiments of the user interface page 300 and the map 1400, with the path 1506 determined in this manner.

More particularly, the user interface page 300 of FIG. 18A has overlaid on the map 1400 the first through fifth search results 408a-e at the first through fifth locations 1502a-e, respectively. The path 1506 comprises two line segments: a first line segment that connects the first location 1502a to an averaged location 1802 determined from an average of the search results 408b-d obtained at the second through fourth locations 1502b-d, and a second line segment that connects the averaged location 1802 to the fifth location 1502e. The search UI module 202 determines the averaged location 1802 from the second through fourth locations 1502b-d as follows. The averaged location 1802 corresponds to an averaged search result generated from the second through fourth search results 408b-d, as follows.

The search results 408b-d are respectively returned with metadata that describes the time at which the search results 408b-d are obtained, the camera 169 used to obtain the search results 408b-d, and a confidence level associated with the search results 408b-d. In at least some example embodiments, a search result 408b-d may only be returned and used to determine the averaged location 1802 if it has a confidence level greater than or equal to a minimum confidence threshold (e.g. 80%). In the depicted example embodiment, the second through fourth results 408b-d are concurrently obtained by the cameras 169 at those respective locations 1502b-d, and consequently the search UI module 202 averages them to determine a single location on the map 1400 at which to place the person-of-interest 308 at that time. However, in at least some different example embodiments, the search UI module 202 may average two or more of the search results 408b-d even if they do not overlap in time. For example, the search UI module 202 may average any two of the search results 408b-d that are not concurrent but that occur within a certain time of each other.

When determining the averaged location 1802 for any particular time, the search UI module 202 determines an average position and confidence of the search results 408b-d being averaged, and a total number of search results 408b-d that are averaged. The average position may comprise an average horizontal position (longitude) and an average vertical position (latitude) on the map 1400. Metadata such as numerical longitude and latitude positions, the number of search results 408b-d averaged to determine the averaged location 1802, and the averaged weight of the averaged location 1802 may be accessed by the user via the user interface page 300, such as by invoking the context menu 312. In at least some different example embodiments, the averaged location 1802 may be determined as a weighted average of the locations 1502b-d of the search results 408b-d, with the weights used in determining the weighted average being the confidence levels of the search results 408b-d. In still other example embodiments, one or more of the search results 408b-d may not be associated with a confidence value at all, and the averaged location 1802 may lack any associated metadata describing a confidence level.

In at least some example embodiments, the cameras 169 that generate the search results 408 may differ in at least one of frame rate and resolution. Without compensating for differences in frame rate and resolution between different cameras 169, the averaged location 1802 generated using the search results 408 from those different cameras 169 may be temporally or spatially biased. For example, if the averaged location 1802 is determined by averaging the locations 1502b-d associated with three different cameras 169 generating different search results 408b-d and the camera 169 at one of the locations 1502b has a frame rate N times greater than the cameras 169 at the other two locations 1502c,d, then an average over a certain period of time may be determined using N times more images from the camera 169 with the higher frame rate than either of the other cameras 169. To compensate for this, the search UI module 202 may decimate the number of images generated from the camera 169 with the higher frame rate by a certain factor (e.g., N) before determining the averaged location 1802. Additionally or alternatively, the search UI module 202 may generate a weighted average (e.g., by weighing the contribution from the camera 169 with the higher frame rate by 1/N) to perform temporal compensation.

As another example, if the averaged location 1802 is determined by averaging the locations 1502b-d associated with three different cameras 169 generating different search results 408b-d and the camera 169 at one of the locations 1502b has a higher resolution than the other cameras 169, the confidence level of the search results 408b from that camera 169 may be higher than the confidence level of the search results 408c,d from the cameras 169 with lower resolutions. To compensate for this spatial bias, the search UI module 202 may access a lookup table stored in the non-volatile storage 120 that contains correction factors taking into account image resolution and distance of an object-of-interest from the camera 169, and determine the averaged location 1802 as a weighted average that applies the correction factor to the higher resolution camera 169.

The JavaScript code below describes an example implementation of how to determine the averaged location 1802 according to the embodiment of FIG. 18A:

```
/ / Initialize variables.
  .map ( (b) => {
    let lat = 0; / / Latitude of each search result 408
    let lon = 0; / / Longitude of each search result 408
    let weight = 0; / / Weight of each search result 408
    let count = 0; / / Number of averaged search results 408
    let time; / / Time of search results 408
/* For each of the search results that are at the same time
(startTime), increase count by 1 and keep a running total of
latitude, longitude, and weight */
  b.forEach ( ( { startTime, camera, confidence } ) => {
    if (camera) {
      lat += camera.lat;
      lon += camera.lon;
      weight += confidence;
      count += 1;
    }
    time = startTime;
  } ) ;
/* If no search results 408 to be averaged, return null.
Otherwise, determine non-weighted average of latitude, longitude,
and weight. */
  if (count === 0) {
    lat = null;
    lon = null;
    weight = null;
  } else {
    lat = lat / count;
    lon = lon / count;
    weight = weight / count;
  }
/* Return averaged atitude, averaged longitude, time, averaged
weight, and total number of search results 408 used for averaging
*/
  return { latlon: [lat, lon], time, avgConfidence: weight,
count } ;
```

In another example embodiment, the code below may be used in place of the analogous code above to determine the averaged location 1802 using confidence weighting:

```
/* For each of the search results that are at the same time
(startTime), increase count by 1 and keep a running total of latitude,
longitude, and weight */
  b.forEach ( ( { startTime, camera, confidence } ) => {
    if (camera) {
      lat += camera.lat * confidence;
      lon += camera.lon * confidence;
      weight += confidence;
      count += 1;
    }
    time = startTime;
  } ) ;
/* If no search results 408 to be averaged, return null.
Otherwise, determine non-weighted average of latitude, longitude,
and weight. */
  if (count === 0) {
    lat = null;
    lon = null;
    weight = null;
  } else {
    weight = weight / count;
    lat = lat / count / weight;
    lon = lon / count / weight;
  }
```

Additionally, the following code may be applied to group the search results 408 by time into different “buckets”. In at least some example embodiments, the buckets are non-overlapping in time. A single time period may, for example, be divided into sequential buckets such that all times during that period fall into one of the buckets. Each non-empty bucket may then be further processed to eventually become one of the averaged locations 1802 on the path 1506 drawn on the map 1400.

path(state) {
const numBuckets = 100;
/ / calculate the first and last timestamps in the result set
const { startTime, endTime } = state.reduce ( (t, result) => ( {
startTime: Math.min(t.startTime, result.startTime),
endTime: Math.max(t.endTime, result.endTime)
} ), { startTime: Infinity, endTime: 0 } ) ;
/ / calculate the duration of each bucket
const increment = (endTime − startTime) / numBuckets;
/ / assign search results to appropriate buckets
let buckets = new Array(numBuckets) ;
state.forEach(result => {
const lastBucket = Math.max(0, Math.floor((result.endTime −
startTime) / increment) − 1) ;
const firstBucket = Math.min(lastBucket, Math.min(99,
Math.ceil ( ( (result.startTime + 1) − startTime) / increment)
− 1) ) ;
for (let i = firstBucket; i <= lastBucket; i++) {
if (!buckets [i] ) {
buckets [i] = [] ;
}
buckets [i] .push ( {
id: result.id,
confidence: result.confidence,
startTime: result.startTime,
} )
}
} ) ;
/ / eliminate empty buckets
buckets = buckets
.filter (b => b !== null)
return buckets;
}

FIG. 18B shows another example embodiment of the user interface page 300 and the map 1400 in which instead of there being a single averaged location 1802 determined from the second through fourth search results 408b-d, there is a first averaged location 1802a determined from averaging the second and third search results 408b,c and a second averaged location 1802b determined from averaging the third and fourth search results 408c,d. The averaging is done in a manner analogous to that described for the single averaged location 1802 shown in FIG. 18A. The path 1506 in FIG. 18B accordingly comprises three linear line segments: a first line segment connecting the first location 1502a to the first averaged location 1802a; a second line segment connecting the first averaged location 1802a to the second averaged location 1802b; and a third line segment connecting the second averaged location 1802b to the fifth location 1502e. In at least some example embodiments in which the line segments between multiple averaged locations 1802 are sufficiently short, the portion of the path 1506 represented by those line segments may resemble a curve or spline.

Generating the averaged location 1802 may be done live as the search UI module 202 is obtaining the search results 408 in real-time from at least one live video stream and/or based on recorded data to reconstruct the person-of-interest's 308 path. Various parameters, such as how many search results 408 to average and whether a weighted average is used may be adjusted to generate a variety of different paths 1506 for review by the user. In at least some example embodiments, the averaged location 1802 may be generated using the most recent search results 408, and the path 1506 may accordingly terminate at the averaged location 1802. The averaged location's 1802 position on the map 1400 may also change as the search UI module 202 obtains new search results 408 and updates the latitude and longitude of the averaged location 1802.

Each of FIGS. 18A and 18B also depicts a direction indicator 1804 on the map 1400. The direction indicator 1804 indicates the direction of travel of the person-of-interest 308 so that a user of the search UI module 202 may quickly identify the most recently available location of the person-of-interest 308 and infer a direction in which the person-of-interest 308 may be traveling. While in FIGS. 18A and 18B the direction indicator 1804 comprises a series of arrows overlaid on the line segment of the path 1506 that terminates at the most recent location 1502e, the direction indicator 1804 may appear differently in different embodiments. For example, the direction indicator 1804 may be spaced apart from the path 1506. The direction indicator 1804 may comprise any suitable indicator to direct the user's attention to an inferred direction of travel of the person-of-interest 308. For example, the direction indicator 1804 may comprise flashing the most recent location 1502e, or flashing all of the locations 1502 in order from the first location 1502a to the fifth location 1502e to indicate a direction of travel of the person-of-interest 308. As another example, the direction indicator 1804 may comprise an arrow attached to the end of and thereby extending the path 1506, with the direction of the arrow indicating an inferred direction of travel.

The search UI module 202 may also determine the speed of the person-of-interest 308 from the search results 408. If two search results 408 are indexed at times t₁ and t₂ and are a distance D apart, the average speed between the locations 1502 corresponding to those results 408 is D/(t₂−t₁). The search UI module 202 may display this average speed, which permits the user to infer locations at which the person-of-interest 308 may have traveled or lingered when not directly observed by at least one of the cameras 169. In at least some example embodiments, the search UI module 202 may determine from the average speed and from the person-of-interest's 308 direction of travel as indicated by the direction indicator 1804 an inferred area in which the person-of-interest 308 may be located. Each of FIGS. 18A and 18B depicts a region 1806 depicting the inferred area based on the last known location of the person-of-interest 308, which is at the fifth location 1502e. As the search UI module 202 receives additional search results 408, the inferred area and consequently the positioning of the region 1806 may change. For example, the user may change the minimum confidence level required to be considered a valid search result 408, and consequently change the number of search results 408 the search UI module 202 uses in determining the path 1506. This may affect the direction and/or speed of travel of the person-of-interest 308, thereby affecting the size and/or positioning of the inferred area and the shape of the region 1806. Additionally or alternatively, the user may confirm that certain search results 408 correspond to the person-of-interest 308, as discussed above in respect of FIG. 4. This may cause the search UI module 202 to re-determine the path 1506 using search results 408 that previously had too low a confidence to be considered, thereby correspondingly altering the path 1506 and the region 1806.

More generally, the search UI module 202 may highlight to the user the fifth location 1502e, which in FIGS. 18A and 18B corresponds to the most recent search result 408e, in any suitable manner. For example, the search UI module 202 may show the fifth location 1502e in a visual state distinct from that of the other locations 1502a-d. Additionally or alternatively, the search UI module 202 may also show the fifth location 1502e in a distinctive visual state if the camera 169 at the fifth location 1502e is currently capturing images of the person-of-interest 308 and the map 1400 is accordingly being updated in real-time. The fifth location 1502e may, for example, be a different color than the other locations 1502a-d by virtue of corresponding to the most recent search result 408e, and may also flash if the camera 169 at the fifth location 1502e is currently capturing images of the person-of-interest 308. When multiple cameras 169 are concurrently capturing images of the person-of-interest 308, all of the locations 1502 corresponding to those cameras 169 may be shown in a distinctive visual state.

The region 1806 in FIGS. 18A and 18B is triangular, with the angle spanned by the two sides contacting the fifth location 1502e representing the scope of reasonably expected deviations from a linear continuation of the path 1506, and the far side of the region 1806 connecting those two sides representing potential distance traveled as determined from the average speed. The far side of the region 1806 accordingly may change its position as more time passes from the time of the most recently obtained search result 408e. In at least some different example embodiments, the region 1806 may be differently shaped. For example, the region 1806 may comprise a circle centered on the fifth location 1502e and having a radius determined by the average speed and time passed since the fifth search result 408e was obtained.

While in at least some of the example embodiments described herein the search UI module 202 presumes the position of the person-of-interest 308 is that of the camera 169 that captures the search result 408, this may differ in at least some different example embodiments. For example, the camera 169 may capture depth data, and the search UI module 202 may accordingly determine the person-of-interest's 308 location on the map 1400 as being spaced away from the location 1502 of the camera 169 by a distance corresponding to that depth.

In FIGS. 16A-16F, the search results 408a-e are based on recorded video. In at least some example embodiments and as discussed above, the search results 408a-e may analogously appear in real-time as the cameras 169 at the first through fifth locations 1502a-e capture images of the person-of-interest 308. This may be done as part of a live search in which the search results 408 are updated continuously or from time-to-time (e.g., periodically, such as every ten seconds). Additionally, while in FIGS. 16A-16F indicators representing the locations 1502a-e are depicted on the map 1400 even before images of the person-of-interest 308 are captured at those locations 1502a-e, in at least some different example embodiments the indicators of the locations 1502a-e may not appear until the time during playback corresponding to when images of the person-of-interest 308 are captured at those locations 1502a-e.

As FIGS. 16A-16F also show the timeline 320, the page 300 shows not just the order in which the search results 408 appear relative to each other, but also relative to time of day. While a single search result 408 is shown in conjunction with each of the camera locations 1502 in FIGS. 16A-16F, in at least some different example embodiments multiple search results 408 may be depicted in association with one or more of the camera locations 1502, as shown in FIG. 15B for example. Additionally or alternatively, the search results 408 in at least some different example embodiments may additionally or exclusively comprise search results 408 that the user has not marked using an indicator 410.

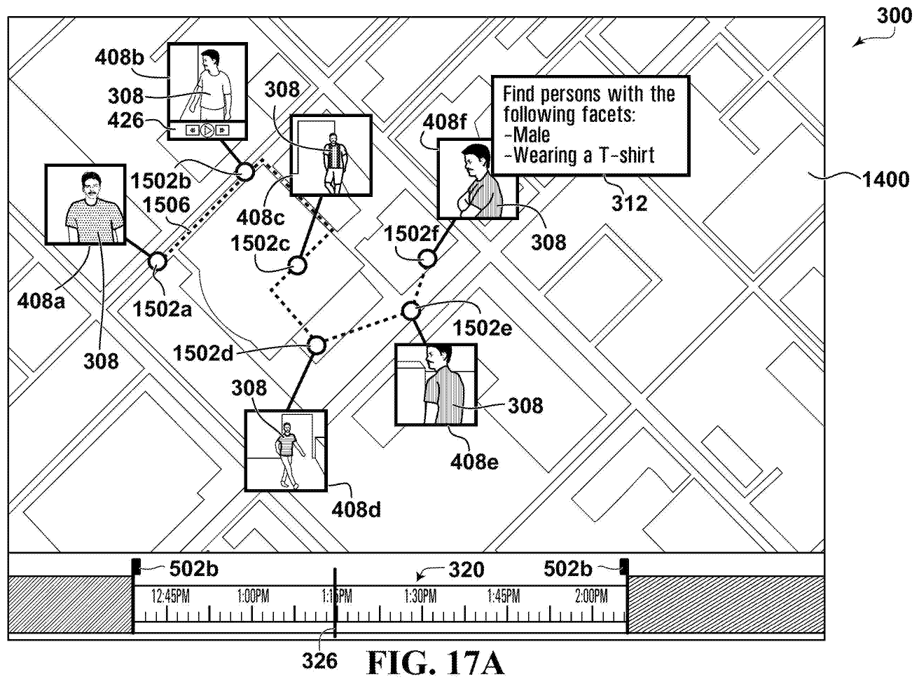

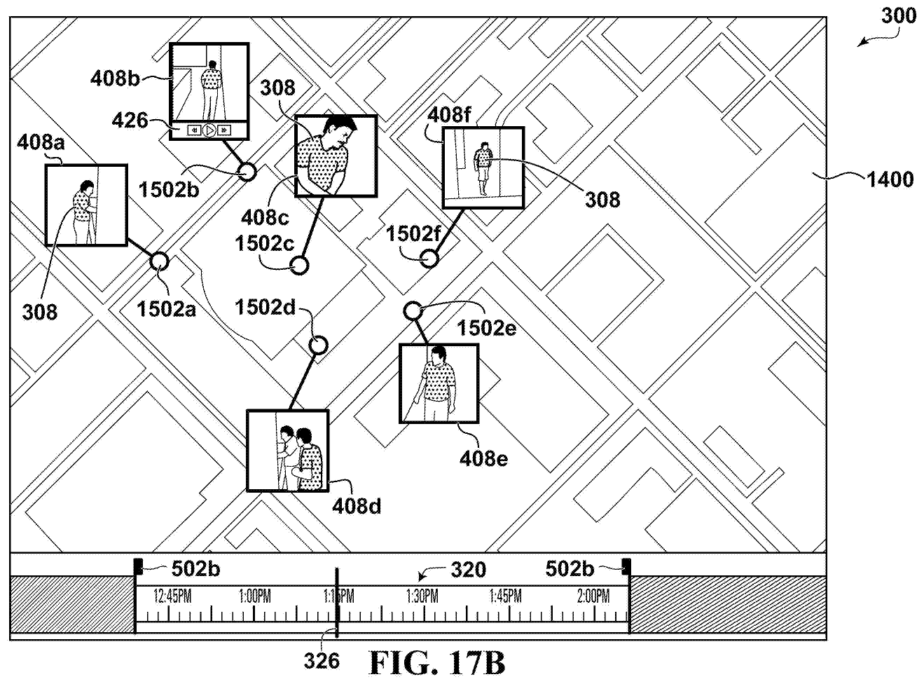

In FIG. 17A, the context menu 312 permits the user to commence another appearance search, analogous to the function the context menu 312 provides in FIG. 15A. More particularly, the context menu 312 permits the search UI module 202 and/or the server system 108 to receive additional search commencement user input in the form of facet search commencement user input from the user, and to accordingly commence a facet search for one or more persons-of-interest 308 that share one or more facets of the person-of-interest 308 depicted in one of the depicted search results 408. In particular, in FIG. 17A the server system 108 identifies that the person-of-interest 308 is depicted in the sixth search result 408f comprises facets have a descriptor of gender (tag: male) and clothing (value: T-shirt), and suggests to the user that a facet search be commenced using the video recordings for persons having facets of identical descriptor and tag. Upon the user's confirming that the facet search is to proceed, the server system 108 performs the search on the video recordings for all persons-of-interest 308 having facets of identical descriptor and tag and updates the page 300 to show the search results 408 of the facet search in FIG. 17B. More particularly, the page 300 of FIG. 17B depicts first through sixth results 408a-f at first through sixth camera locations 1502a-f, respectively; in contrast to the results 408a-f depicted in FIG. 15C, the results 408a-f of FIG. 17B are of multiple persons-of-interest 308 who the server system 108 has determined share the facets of being a male wearing a T-shirt. While in FIG. 17A the user is presented with what the server system 108 determines are the facets of the person-of-interest 308 shown in the sixth result 408f and the user commences a facet search using all those facets, in at least some different example embodiments the user may select a subset of the facets the server system 108 identifies, or input one or more facets of the person-of-interest 308 without those facets first being identified by the server system 108. For example, the user may select a particular facet depicted in one of the search results 406 (e.g., a person-of-interest's 308 T-shirt), thereby indicating to the server system 108 that the facet search is to proceed based on the descriptor and tag of that particular facet. As another example, the user may select multiple facets from one or more person-of-interests 308 depicted in the search results 406 concurrently, and then cause the server system 108 to perform a facet search for all of those facets.

Additionally or alternatively, following an initial selection of facets based on the search results 406 depicted on the page 300, the user may revise or add to those facets by providing inputs removed from the map 1400, such as by using the menus 1004 and 1020a,b of FIGS. 10B and 10C. For example, the user may select a facet of a particular descriptor and tag depicted on the page 300, and the user may subsequently change one or both of the facet's descriptor and tag using one of the menus 1004 and 1020a,b.

Via the page 300, the user may accordingly commence a search for a person-of-interest 308 (regardless of the person-of-interest's 308 facets), or a search for one or more facets of a person-of-interest 308 shown in one of the search results 406. The user may also chain these searches together. For example, the user may commence a search for a person-of-interest 308 regardless of that person-of-interest's 308 facets, and then commence a facet search based on one or more facets of one or more persons depicted in the consequent search results 406, regardless of whether the result 406 depicts the actual person-of-interest 308 for whom the user was searching or a false positive. The user may then analogously perform one or more appearance searches for a person-of-interest 308 (regardless of his or her facets) and/or one or more facet searches from the results, as desired. Similarly, the user may start the chain by performing a facet search, and based on the results 406 of the facet search commence an appearance search for a particular person-of-interest 308 (regardless of his or her facets).

At least some of the foregoing example embodiments display results of an appearance search on the map 1400. In at least some different example embodiments, different types of search results may additionally or alternatively be displayed on the map 1400. For example, the search UI module 202 may display results of a non-appearance search performed using video analytics, or of a motion search. The search UI module 202 may depict, for example, lists of different video analytics-detected events detected using the analytics engine module 172 on the map 1400, with one or more of the locations 1502 being associated with a list of events detected at that location 1502. Example video analytics events comprise one or more of foreground/background segmentation, object detection, object tracking, object classification, virtual tripwire, anomaly detection, facial detection, facial recognition, license plate recognition, identifying objects “left behind”, monitoring objects (i.e. to protect from stealing), business intelligence and deciding a position change action.

The map integration described in respect of FIGS. 14-17B are depicted in respect of searches performed on one or more persons-of-interest 308. However, in at least some example embodiments (not depicted), the map integration may be performed in respect of searches performed on one or more objects-of-interest more generally, such as vehicles. Example vehicle facets in one or more of such embodiments comprise vehicle make, vehicle model, and vehicle color. For example, the system 108 may identify and track a vehicle using license plate recognition. The tracking may be done, for example, live and in real-time during a pursuit sequence; additionally or alternatively, the search UI module 202 may update the map 1400 using a recorded video stream of the vehicle.

Although example embodiments have described a reference image for a search as being taken from an image within recorded video, in some example embodiments it may be possible to conduct a search based on a scanned photograph or still image taken by a digital camera. This may be particularly true where the photo or other image is, for example, taken recent enough such that the clothing and appearance is likely to be the same as what may be found in the video recordings.

As should be apparent from this detailed description, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot display content, such as a map, on a display, among other features and functions set forth herein).

In the foregoing specification, specific embodiments have been described.

However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending in the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like.

However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
receiving search commencement input requesting that an appearance search for one or more objects-of-interest commence;
in response to the search commencement input, searching one or more video recordings for the one or more objects-of-interest; and
displaying, in conjunction with a map on a display, one or more appearance search results depicting the one or more objects-of-interest, wherein each of the appearance search results depicts the one or more objects-of-interest as captured by a camera at a time during the one or more video recordings, and is depicted in conjunction with the map at a location indicative of a geographical location of the camera.

2. The method of claim 1, wherein the appearance search results appear in an order corresponding to a sequence in which the appearance search results appear in the one or more video recordings.

3. The method of claim 2, further comprising:
receiving playback input indicating that the appearance search results are to appear, wherein the playback input comprises a playback speed at which the appearance search results are to appear; and
only causing the appearance search results to appear once the playback input is received, wherein the times at which the appearance search results appear are adjusted in proportion to the playback speed.

4. The method of claim 3, further comprising displaying a path connecting sequentially appearing ones of the appearance search results.

5. The method of claim 4, further comprising:
determining whether at least one of the appearance search results is located within a building; and
if the at least one of the appearance search results is located within the building, determining at least one of an entrance and exit of the building,
wherein the path passes through the at least one of an entrance and exit.

6. The method of claim 1, wherein searching the one or more video recordings comprises searching for a single object-of-interest regardless of facets of the single object-of-interest.

7. The method of claim 6, wherein the appearance search results comprise the single object-of-interest, and further comprising:
receiving additional search commencement input indicating that a search is to be done for one or more objects-of-interest that share one or more facets of the single object-of-interest;
in response to the additional search commencement input, searching the one or more video recordings for the one or more objects-of-interest that share the one or more facets of the single object-of-interest; and
updating, on the display, the one or more appearance search results to depict the one or more objects-of-interest that share the one or more facets of the single object-of-interest.

8. The method of claim 7, wherein the appearance search results comprise multiple objects-of-interest sharing one or more facets of identical descriptor and tag, and further comprising:
receiving additional search commencement input indicating that a search is to be done for a single object-of-interest comprising part of the appearance search results;
in response to the additional search commencement input, searching the one or more video recordings for the single object-of-interest interest comprising part of the appearance search results regardless of facets of the single object-of-interest; and
updating, on the display, the one or more appearance search results to depict the single object-of-interest comprising part of the appearance search results.

9. The method of claim 1, wherein at least one of the appearance search results is overlaid on the map.

10. A method comprising:
receiving search commencement input requesting that a search for one or more objects-of-interest commence;
in response to the search commencement input, searching one or more videos for the one or more objects-of-interest;
obtaining at least two search results in response to searching the one or more videos, wherein each of the search results is associated with a geographical location indicative of a camera used to capture an image used to generate the search result;
determining an averaged location by averaging the geographical location of each of the search results; and
identifying, in conjunction with a map on a display, the object-of-interest as being at the averaged location.

11. The method of claim 10, wherein each of the search results comprises metadata indicating a confidence level of the search result, and wherein determining the averaged location comprises determining an average confidence level of the search results.

12. The method of claim 11, wherein the averaged location is a weighted average that is weighted by the confidence level of each of the search results.

13. The method of claim 10, further comprising displaying a path connecting sequentially appearing ones of the search results.

14. The method of claim 13, wherein the path terminates at the averaged location.

15. The method of claim 14, further comprising:
determining a direction indicator indicating a direction of travel of the object-of-interest; and
displaying, in conjunction with the map on the display, the direction indicator.

16. The method of claim 15, wherein the direction indicator is overlaid on the path.

17. The method of claim 15, wherein the direction indicator is attached to an end of the path.

18. The method of claim 15, further comprising:
determining an average speed of the object-of-interest;
determining, from a most recent one of the search results, the average speed of the object-of-interest, and the direction of travel of the object-of-interest, an inferred area in which the object-of-interest may be located; and
displaying, in conjunction with the map on the display, a region depicting the inferred area.

19. A system comprising:
a display;
an input device;
a processor communicatively coupled to the display and the input device; and
a memory communicatively coupled to the processor and having stored thereon computer program code that is executable by the processor, wherein the computer program code, when executed by the processor, causes the processor to:
receive search commencement input requesting that an appearance search for one or more objects-of-interest commence;
in response to the search commencement input, searching one or more video recordings for the one or more objects-of-interest; and
display, in conjunction with a map on a display, one or more appearance search results depicting the one or more objects-of-interest, wherein each of the appearance search results depicts the one or more objects-of-interest as captured by a camera at a time during the one or more video recordings, and is depicted in conjunction with the map at a location indicative of a geographical location of the camera.

20. The system of claim 19 wherein the appearance search results appear in an order corresponding to a sequence in which the appearance search results appear in the one or more video recordings.
